(19) United States
(12) Patent Application Publication
(10) Pub. No.: US 2021/0132387 A1
(43) Pub. Date: May 6, 2021

(54) FLUID LENS WITH OUTPUT GRATING

(71) Applicant: Facebook Technologies, LLC, Menlo Park, CA (US)

(72) Inventors: Robert Edwards Stevens, Eynsham (GB); Thomas Norman Llyn Jacoby, Oxford (GB)

(21) Appl. No.: 17/081,157

(22) Filed: Oct. 27, 2020

Related U.S. Application Data
(60) Provisional application No. 62/930,797, filed on Nov. 5, 2019.

(51) Int. Cl. G02B 27/01; G02B 3/14; F21V 8/00; G02C 7/08; G02B 26/00

(52) U.S. Cl. CPC G02B 27/0172; G02B 3/14; G02B 2027/0178; G02C 7/085; G02B 26/004; G02B 6/0036

(57) ABSTRACT

In some examples, a device, such as an augmented reality or virtual reality device, may include one or more waveguide displays and one or more adjustable lenses, such as adjustable fluid lenses. In some examples, a device includes a waveguide display and a rear lens assembly that together provide a negative optical power for augmented reality light. A front lens assembly, the waveguide display, and the rear lens assembly may together provide an approximately zero optical power for real-world light. In some examples, an eye-side optical element having a negative optical power may defocus light from the waveguide display. Example devices may allow the adjustable lens (or lenses) to have a reduced mass and/or a faster response time.

### CROSS REFERENCE TO RELATED APPLICATION

This application claims the benefit of U.S. Provisional Application No. 62/930,797, filed Nov. 5, 2019, the disclosure of which is incorporated, in its entirety, by this reference.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIGS. 1A-1C illustrate example fluid lenses.

FIGS. 2A-2G illustrate example fluid lenses and adjustment of the optical power of the fluid lenses.

FIG. 3 illustrates an example ophthalmic device.

FIGS. 4A-4B illustrate a fluid lens having a membrane assembly including a support ring.

FIG. 5 illustrates deformation of a non-circular fluid lens.

FIGS. 6, 7, and 8 illustrate vergence and accommodation distances, for example, within an augmented reality device including one or more adjustable lenses.

FIGS. 9A and 9B illustrate an optical configuration including a front lens assembly, a waveguide display, and a rear lens assembly.

FIG. 10 illustrates an eyeshape outline and a neutral circle.

FIGS. 11 and 12 illustrate optical powers associated with various surfaces of example optical configurations.

FIGS. 13A and 13B show lens thickness and fluid mass as a function of waveguide display optical power, for an example optical configuration.

FIGS. 14 and 15 illustrate optical powers associated with various surfaces of example optical configurations.

FIGS. 16A and 16B show lens thickness and fluid mass as a function of waveguide display optical power, for an example optical configuration.

FIG. 17 shows an example method of operating an augmented reality device.

FIG. 18 illustrates an example control system.

FIG. 19 illustrates an example display device.

FIG. 20 illustrates an example waveguide display.

FIG. 21 is an illustration of an exemplary artificial-reality headband that may be used in connection with some embodiments of this disclosure.

FIG. 22 is an illustration of exemplary augmented-reality glasses that may be used in connection with some embodiments of this disclosure.

FIG. 23 is an illustration of an exemplary virtual-reality headset that may be used in connection with some embodiments of this disclosure.

FIG. 24 is an illustration of exemplary haptic devices that may be used in connection with some embodiments of this disclosure.

FIG. 25 is an illustration of an exemplary virtual-reality environment according to some embodiments of this disclosure.

FIG. 26 is an illustration of an exemplary augmented-reality environment according to some embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and are described in detail herein. However, the exemplary embodiments described herein are not intended to be limited to the particular forms disclosed. The present disclosure includes all modifications, equivalents, and alternatives falling within the scope of the appended claims.

### DETAILED DESCRIPTION OF EXEMPLARY EMBODIMENTS

The present disclosure is generally directed to devices including fluid or liquid lenses, including adjustable liquid lenses. Fluid lenses are useful in a variety of applications. Improvements in the performance of such devices would, therefore, be of value in various applications. As is explained in greater detail below, embodiments of the present disclosure may be directed to devices and systems including fluid lenses, methods of device fabrication, and methods of device operation. In some examples, such devices may include eyewear devices, such as spectacles, sunglasses, goggles, visors, eye protection devices, augmented reality devices, virtual reality devices, and the like. Embodiments of the present disclosure may also include devices having one or more fluid lenses and a waveguide display assembly.

Adjustable fluid lenses are useful for ophthalmic, virtual reality (VR), and augmented reality (AR) devices. In some example AR and/or VR devices, one or more fluid lenses may be used for the correction of what is commonly known as the vergence accommodation conflict (VAC). Examples described herein may include such devices, including fluid lenses for the correction of VAC. Examples disclosed herein may also include fluid lenses, membrane assemblies (which may include a membrane and, e.g., a peripheral structure such as a support ring or a peripheral guide wire), and devices including one or more fluid lenses and waveguide display assemblies configured to provide augmented reality image elements.

Embodiments described herein may include adjustable fluid lenses including a substrate and a membrane, at least in part enclosing a lens enclosure. The lens enclosure may also be referred to hereinafter as an “enclosure” for conciseness. The enclosure may enclose a lens fluid (sometimes herein referred to a “fluid” for conciseness), and the interior surface of the enclosure may be proximate or adjacent the lens fluid.

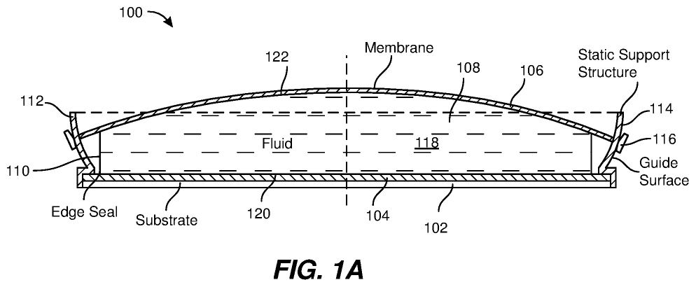

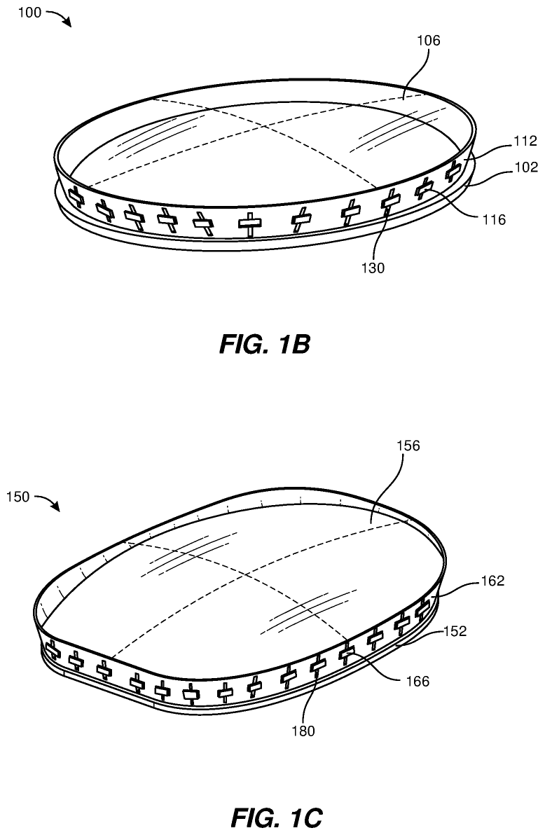

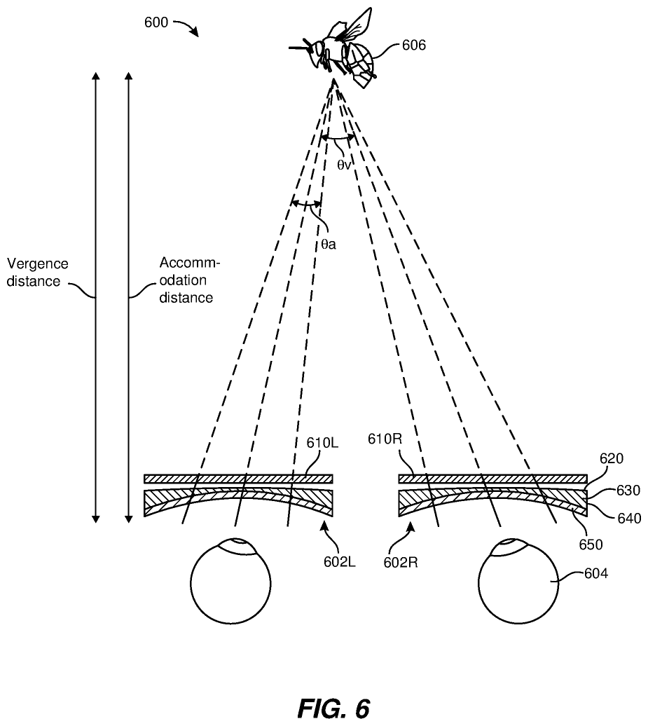

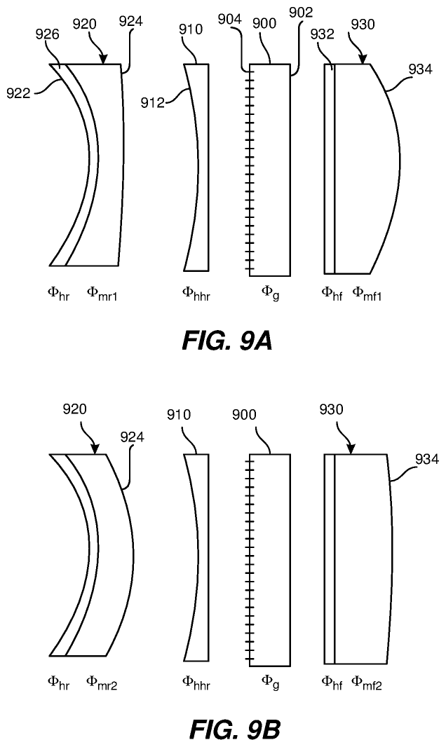

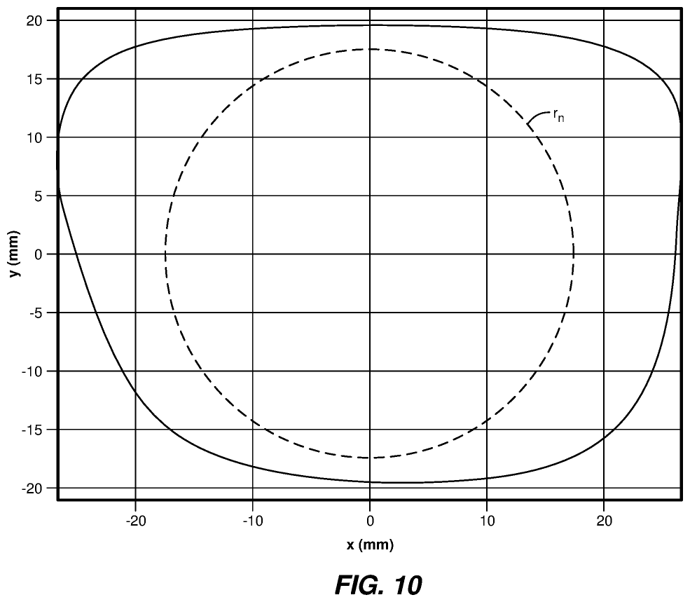

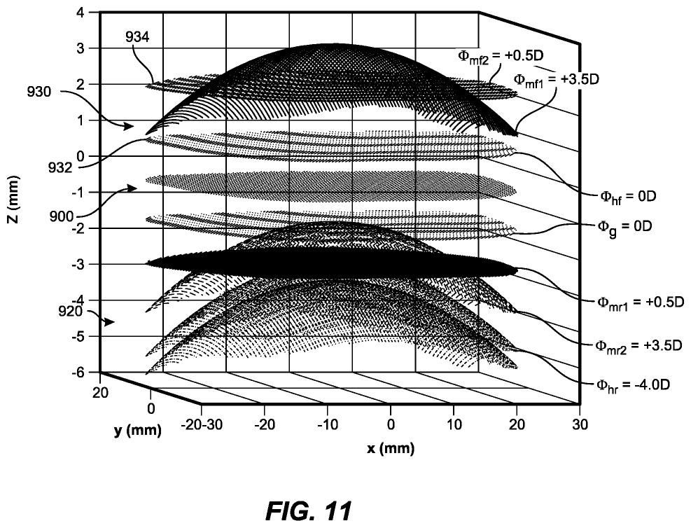

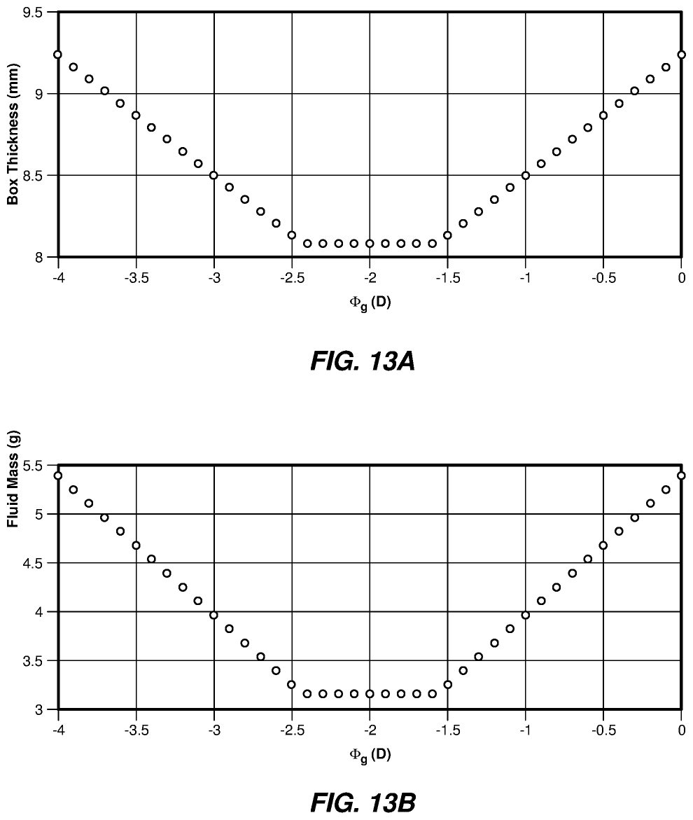

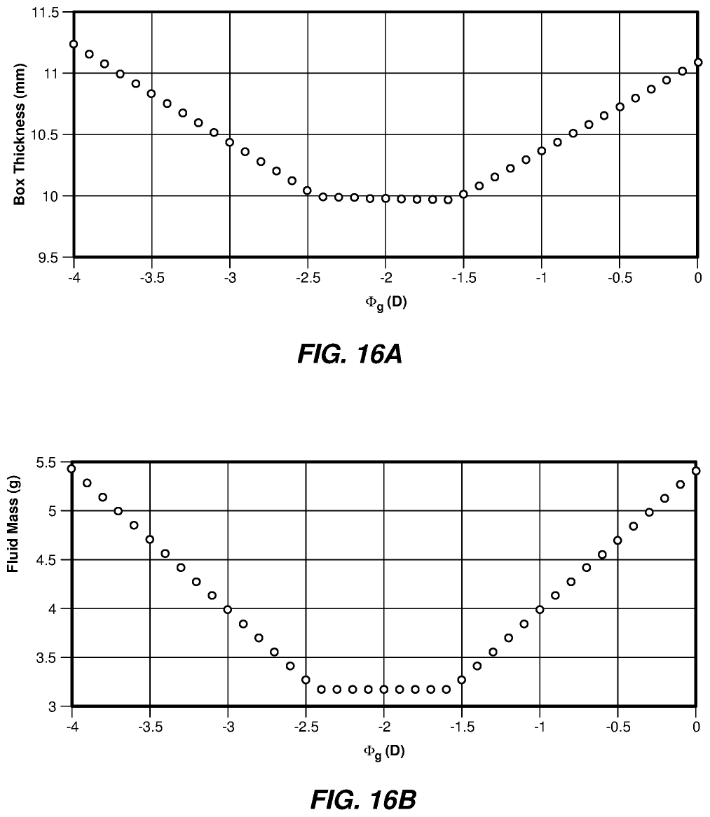

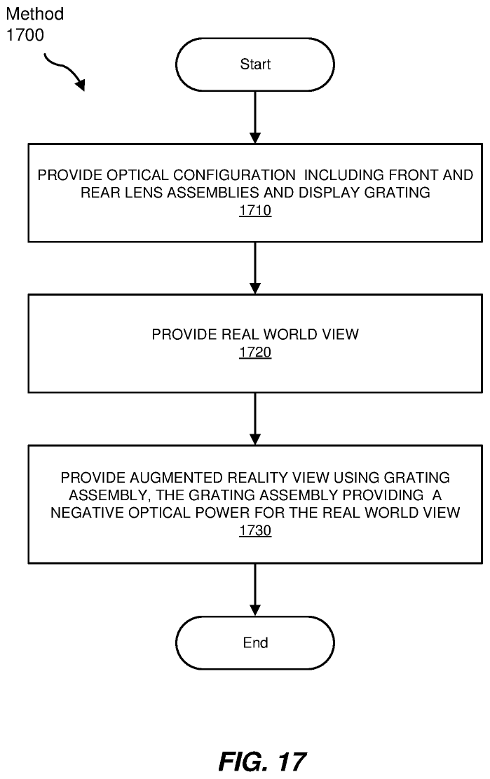

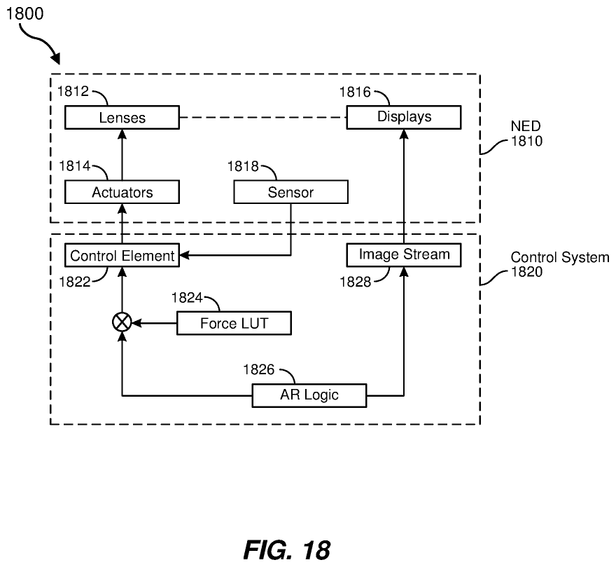

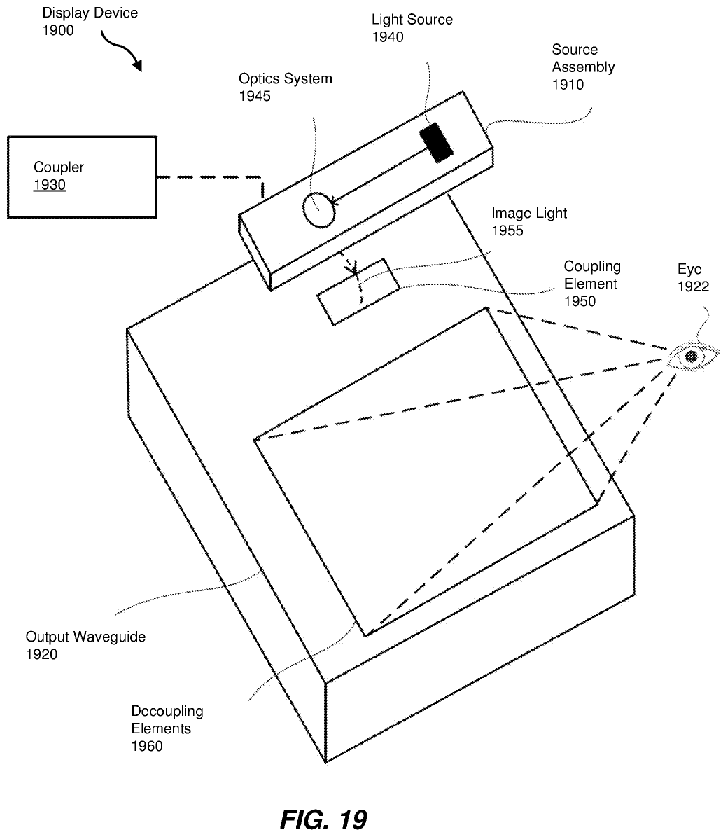

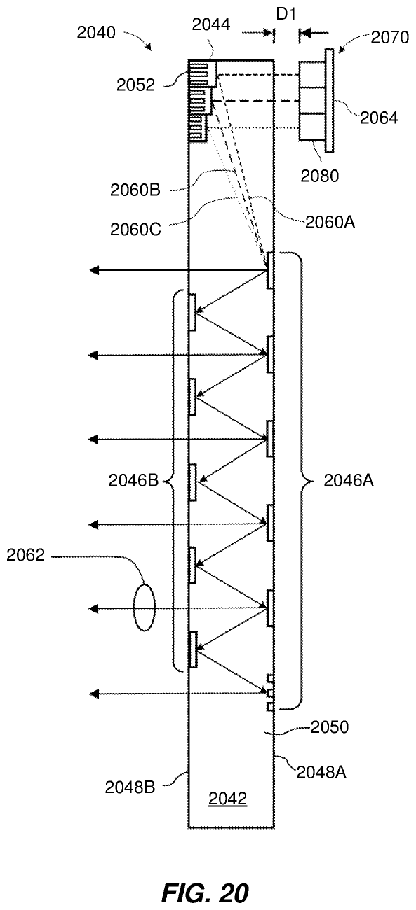

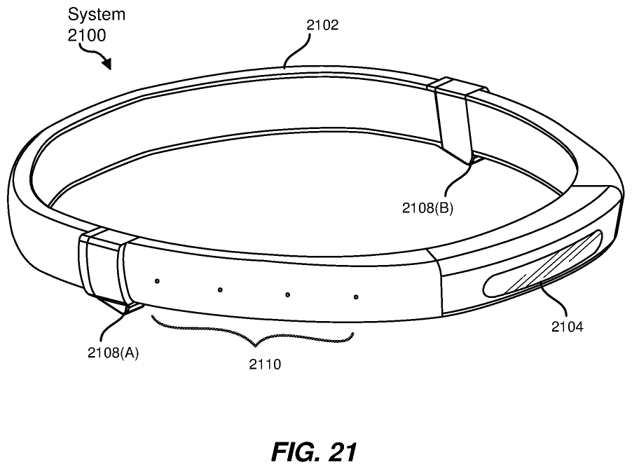

The following provides, with reference to FIGS. 1-26, detailed descriptions of such devices, fluid lenses, optical configurations, methods, and the like. FIGS. 1-5 illustrate example fluid lenses. FIGS. 6-8 illustrate vergence and accommodation distances, for example, within an augmented reality device having adjustable lenses. FIGS. 9A and 9B illustrate an optical configuration including a front lens assembly, a waveguide display, and a rear lens assembly. FIG. 10 illustrates an eyeshape outline and a neutral circle. FIGS. 11-12 and 14-15 illustrate optical powers associated with various surfaces of example optical configurations. FIGS. 13A-13B and 16A-16B show example lens thickness and fluid mass as a function of waveguide display optical power. FIG. 17 shows an example method, for example, of operating an augmented reality device. FIG. 18 illustrates an example control system. FIG. 19 illustrates an example display device. FIG. 20 illustrates an example waveguide display. FIGS. 21-26 illustrate example augmented reality and/or virtual reality devices, which may include one or more fluid lenses according to embodiments of this disclosure.

Features from any of the embodiments described herein may be used in combination with one another in accordance with the general principles described herein. These and other embodiments, features, and advantages will be more fully understood upon reading the detailed description in conjunction with the accompanying drawings and claims.

FIG. 1A depicts a cross-section through a fluid lens, according to some examples. The fluid lens 100 illustrated in this example includes a substrate 102, a substrate coating 104, a membrane 106, a fluid 108 (denoted by dashed horizontal lines), an edge seal 110, a support structure 112 providing a guide surface 114, and a membrane attachment 116. In this example, the substrate 102 is a generally rigid, planar substrate having a lower (as illustrated) outer surface, and an interior surface on which the substrate coating 104 is supported. However, one or both surfaces of the substrate may be spherical, sphero-cylindrical, or formed with a more complex surface shape of the kind typically found in an ophthalmic lens (e.g., progressive, digressive, bifocal, and the like). In this example, the interior surface 120 of the substrate coating 104 is in contact with the fluid 108. The membrane 106 has an upper (as illustrated) outer surface and an interior surface 122 bounding the fluid 108. The substrate coating 104 is optional, and may be omitted.

The fluid 108 is enclosed within an enclosure 118, which is at least in part defined by the substrate 102 (along with the substrate coating 104), the membrane 106, and the edge seal 110, which here cooperatively define the enclosure 118 in which the fluid 108 is located. The edge seal 110 may extend around the periphery of the enclosure 118 and retain (in cooperation with the substrate and the membrane) the fluid within the enclosed fluid volume of the enclosure 118. In some examples, an enclosure may be referred to as a cavity or lens cavity.

In this example, the membrane 106 is shown with a curved profile so that the enclosure has a greater thickness in the center of the lens than at the periphery of the enclosure (e.g., adjacent the edge seal 110). The profile of the membrane may be adjustable to permit adjusting the optical power of the fluid lens 100. In some examples, the fluid lens may be a plano-convex lens, with the planar surface being provided by the substrate 102 and the convex surface being provided by the membrane 106. A plano-convex lens may have a thicker layer of lens fluid around the center of the lens. In some examples, the exterior surface of a membrane may provide the convex surface, with the interior surface being substantially adjacent the lens fluid.

The support structure 112 (which in this example may include a guide slot through which the membrane attachment 116 may extend) may extend around the periphery (or within a peripheral region) of the substrate 102, and may attach the membrane to the substrate. The support structure may provide a guide path, in this example a guide surface 114 along which a membrane attachment 116 (e.g., located within an edge portion of the membrane) may slide. The membrane attachment may provide a control point for the membrane, so that the guide path for the membrane attachment may provide a corresponding guide path for a respective control point.

The fluid lens 100 may include one or more actuators (not shown in FIG. 1A) that may be located around the periphery of the lens and may be part of or mechanically coupled to the support structure 112. The actuators may exert a controllable force on the membrane at one or more control points, such as provided by membrane attachment 116, that may be used to adjust the curvature of the membrane surface and hence at least one optical property of the lens, such as focal length, astigmatism correction, surface curvature, cylindricity, or any other controllable optical property. In some examples, the membrane attachment may be attached to an edge portion of the membrane, or to a peripheral structure extending around the periphery of the membrane (such as a peripheral guide wire, or a guide ring), and may be used to control the curvature of the membrane.

In some examples, FIG. 1A may represent a cross-section through a circular lens, though examples fluid lenses may also include non-circular lenses, as discussed further below.

FIG. 1B shows a fluid lens, of which FIG. 1A may be a cross-section. The figure shows the fluid lens 100, including the substrate 102, the membrane 106, and the support structure 112. In this example, the fluid lens 100 may be a circular fluid lens. The figure shows the membrane attachment 116 as moveable along a guide path defined by the guide slot 130 and the profile of the guide surface 114 (shown in FIG. 1A). The dashed lines forming a cross are visual guides indicating a general exterior surface profile of the membrane 106. In this example, the membrane profile may correspond to a plano-convex lens.

FIG. 1C shows a non-circular lens 150 that may otherwise be similar to the fluid lens 100 of FIG. 1B and may have a similar configuration. The non-circular lens 150 includes substrate 152, membrane 156, and support structure 162. The lens has a similar configuration of the membrane attachment 166, movable along a guide path defined by the guide slot 180. The profile of a guide path may be defined by the surface profile of the support structure 162, through which the guide slot is formed. The cross-section of the lens may be analogous to that of FIG. 1A. The dashed lines forming a cross on the membrane 156 are visual guides indicating a general exterior surface profile of the membrane 156. In this example, the membrane profile may correspond to a plano-convex lens.

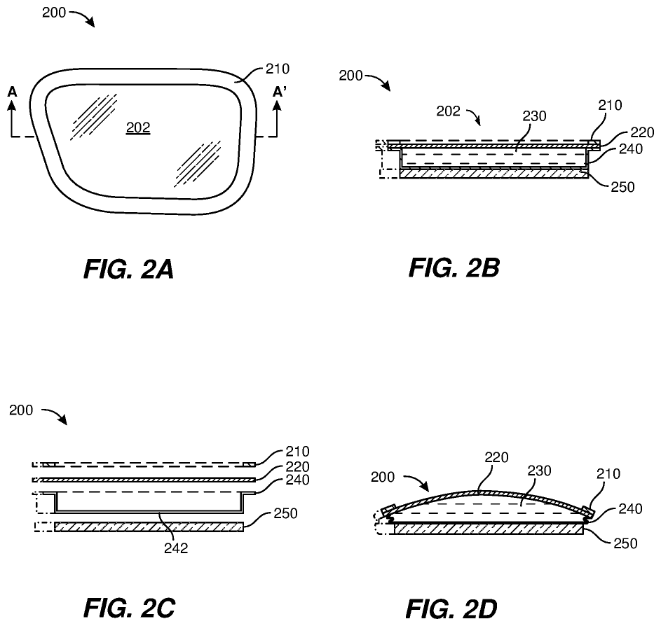

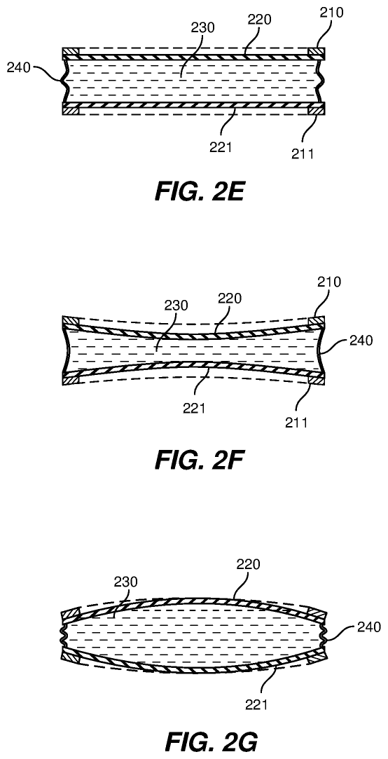

FIGS. 2A-2D illustrate an ophthalmic device 200 including a fluid lens 202, according to some examples. FIG. 2A shows a portion of an ophthalmic device 200, which includes a portion of a peripheral structure 210 (which may include a guide wire or a support ring) supporting a fluid lens 202.

In some examples, the lens may be supported by a frame. An ophthalmic device (e.g., spectacles, goggles, eye protectors, visors, and the like) may include a pair of fluid lenses, and the frame may include components configured to support the ophthalmic device on the head of a user, for example, using components that interact with (e.g., rest on) the nose and/or ears of the user.

FIG. 2B shows a cross-section through the ophthalmic device 200, along A-A′ as shown in FIG. 2A. The figure shows the peripheral structure 210 and the fluid lens 202. The fluid lens 202 includes a membrane 220, lens fluid 230, an edge seal 240, and a substrate 250. In this example, the substrate 250 includes a generally planar, rigid layer. The figure shows that the fluid lens may have a planar-planar configuration, which in some examples may be adjusted to a plano-concave and/or plano-convex lens configuration. The substrate 250 may, in some examples, include a non-planar optical surface having fixed optical power(s).

In some examples disclosed herein, one or both surfaces of the substrate may include a concave or convex surface, and in some examples the substrate may have a non-spherical surface such as a toroidal or freeform optical progressive or digressive surface. In some examples, a substrate may have a concave or convex exterior substrate surface, and an interior surface substantially adjacent the fluid. In various examples, the substrate may include a plano-concave, plano-convex, biconcave, biconvex, or concave-convex (meniscus) lens, or any other suitable optical element. In some examples, one or both surfaces of the substrate may be curved. For example, a fluid lens may be a meniscus lens having a substrate (e.g., a generally rigid substrate having a concave exterior substrate surface and a convex interior substrate surface), a lens fluid, and a convex membrane exterior profile. The interior surface of a substrate may be adjacent to the fluid, or adjacent to a coating layer in contact with the fluid.

FIG. 2C shows an exploded schematic of the device shown in FIG. 2B, in which corresponding elements have the same numbering as discussed above in relation to FIG. 2A. In this example, the edge seal is joined with a central seal portion 242 extending over the substrate 250.

In some examples, the central seal portion 242 and the edge seal 240 may be a unitary element. In other examples, the edge seal may be a separate element, and the central seal portion 242 may be omitted or replaced by a coating formed on the substrate. In some examples, a coating may be deposited on the interior surface of the seal portion and/or edge seal. In some examples, the lens fluid may be enclosed in a flexible enclosure (sometimes referred to as a bag) that may include an edge seal, a membrane, and a central seal portion. In some examples, the central seal portion may be adhered to a rigid substrate component and may be considered as part of the substrate. In some examples, the coating may be deposited on at least a portion of the enclosure surface (e.g., the interior surface of the enclosure). The enclosure may be provided, at least in part, by one or more of the following: a substrate, an edge seal, a membrane, a bag, or other lens component. The coating may be applied to at least a portion of the enclosure surface at any suitable stage of lens fabrication, for example, to one or more lens components (e.g., the interior surface of a substrate, membrane, edge seal, bag, or the like) before, during, or after lens assembly. For example, a coating may be formed before lens assembly (e.g., during or after fabrication of lens components); during lens assembly; after assembly of lens components but before introduction of the fluid to the enclosure; or by introduction of a fluid including a coating material into the enclosure. In some examples, a coating material (such as a coating precursor) may be included within the fluid introduced into the enclosure. The coating material may form a coating on at least a portion of the enclosure surface adjacent the fluid.

FIG. 2D shows adjustment of the device configuration, for example, by adjustment of forces on the membrane using actuators (not shown). As shown, the device may be configured in a planar-convex fluid lens configuration. In an example plano-convex lens configuration, the membrane 220 tends to extend away from the substrate 250 in a central portion.

In some examples, the lens may also be configured in a planar-concave configuration, in which the membrane tends to curve inwardly towards the substrate in a central portion.

FIG. 2E illustrates a similar device to FIG. 2B, and element numbering is similar. However, in this example, the substrate 250 of the example of FIG. 2B is replaced by a second membrane 221, and there is a second peripheral structure (such as a second support ring) 211. In some examples disclosed herein, the membrane 220 and/or the second membrane 221 may be integrated with the edge seal 240.

FIG. 2F shows the dual membrane fluid lens of FIG. 2E in a biconcave configuration. For example, application of negative pressure to the lens fluid 230 may be used to induce the biconcave configuration. In some examples, the membrane 220 and second membrane 221 may have similar properties, and the lens configuration may be generally symmetrical, for example, with the membrane and second membrane having similar radii of curvature (e.g., as a symmetric biconvex or biconcave lens). In some examples, the lens may have rotational symmetry about the optical axis of the lens, at least within a central portion of the membrane, or within a circular lens. In some examples, the properties of the two membranes may differ (e.g., in one or more of thickness, composition, membrane tension, or in any other relevant membrane parameter), and/or the radii of curvature may differ. In these examples, the membrane profiles have a negative curvature that corresponds to a concave curvature. The membrane profile may relate to the external shape of the membrane. A negative curvature may have a central portion of the membrane closer to the optical center of the lens than a peripheral portion (e.g., as determined by radial distances from the center of the lens).

FIG. 2G shows the dual membrane fluid lens of FIG. 2E in a biconvex configuration, with corresponding element numbers.

In some examples, an ophthalmic device, such as an eyewear device, includes one or more fluid lenses. An example device includes at least one fluid lens supported by eyeglass frames. In some examples, an ophthalmic device may include an eyeglass frame, goggles, or any other frame or head-mounted structure to support one or more fluid lenses, such as a pair of fluid lenses.

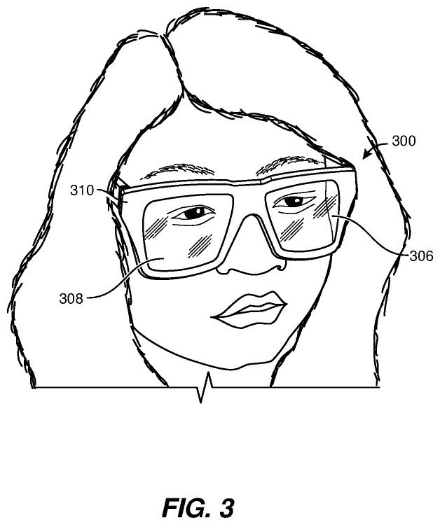

FIG. 3 illustrates an ophthalmic device, in this example an eyewear device, including a pair of fluid lenses, according to some examples. The eyewear device 300 may include a pair of fluid lenses (306 and 308) supported by a frame 310 (which may also be referred to as an eyeglass frame). The pair of fluid lenses 306 and 308 may be referred to as left and right lenses, respectively (from the viewpoint of the user).

In some examples, an eyewear device (such as eyewear device 300 in FIG. 3) may include an ophthalmic device (such as eyeglasses or spectacles), smart glasses, a virtual reality headset, an augmented reality device, a head-up device, visor, goggles, other eyewear, other device, or the like. In such eyewear devices, the fluid lenses 306, 308 may form the primary vision-correcting or adjusting lenses which are positioned in a user's field of view in use. An ophthalmic device may include fluid lenses that have an optical property (such as an optical power, astigmatism correction, cylindricity, or other optical property) corresponding to a prescription, for example, as determined by an eye examination. An optical property of the lens may be adjustable, for example, by a user or by an automated system. Adjustments to the optical property of a fluid lens may be based on the activity of a user, the distance to an observed article, or other parameter. In some examples, one or more optical properties of an eyewear device may be adjusted based on a user identity. For example, an optical property of one or more lenses within an AR and/or VR headset may be adjusted based on the identity of the user, which may be determined automatically (e.g., using a retinal scan) or by a user input.

In some examples, a device may include a frame (such as an eyeglass frame) that may include or otherwise support one or more of any of the following: a battery, a power supply or power supply connection, other refractive lenses (including additional fluid lenses), diffractive elements, displays, eye-tracking components and systems, motion tracking devices, gyroscopes, computing elements, health monitoring devices, cameras, and/or audio recording and/or playback devices (such as microphones and speakers). The frame may be configured to support the device on a head of the user.

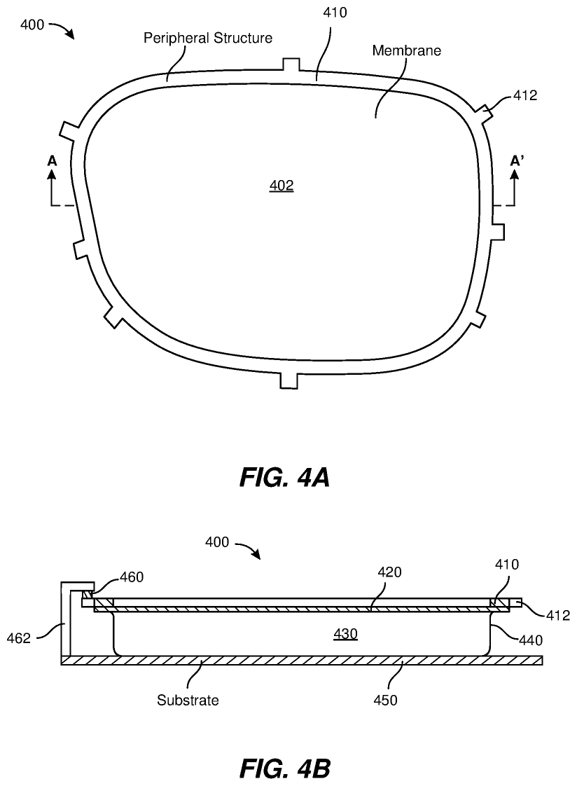

FIG. 4A shows an example fluid lens 400 including a peripheral structure 410 that may generally surround a fluid lens 402. The peripheral structure 410 (in this example, a support ring) includes membrane attachments 412 that may correspond to the locations of control points for the membrane of the fluid lens 402. A membrane attachment may be an actuation point, where the lens may be actuated by displacement (e.g., by an actuator acting along the z-axis) or moved around a hinge point (e.g., where the position of the membrane attachment may be an approximately fixed distance “z” from the substrate). In some examples, the peripheral structure and hence the boundary of the membrane may flex freely between neighboring control points. Hinge points may be used in some examples to prevent bending of the peripheral structure (e.g., a support ring) into energetically favorable, but undesirable, shapes.

A rigid peripheral structure, such as a rigid support ring, may limit adjustment of the control points of the membrane. In some examples, such as a non-circular lens, a deformable or flexible peripheral structure, such as a guide wire or a flexible support ring, may be used.

FIG. 4B shows a cross-section of the example fluid lens 400 (e.g., along A-A′ as denoted in FIG. 4A). The fluid lens includes a membrane 420, fluid 430, edge seal 440, and substrate 450. The edge seal 440 may be flexible and/or collapsible. In some examples, the peripheral structure 410 may surround and be attached to the membrane 420 of the fluid lens 402. The peripheral structure may include membrane attachments 412 that may provide the control points for the membrane. The position of the membrane attachments (e.g., relative to a frame, substrate, or each other) may be adjusted using one or more actuators, and used to adjust, for example, the optical power of the lens. A membrane attachment having a position adjusted by an actuator may also be referred to as an actuation point, or a control point. Membrane attachments may also include non-actuation points, such as hinge points.

In some examples, an actuator 460 may be attached to actuator support 462, and the actuator may be used to vary the distance between the membrane attachment and the substrate, for example, by urging the membrane attachment along an associated guide path. In some examples, the actuator may be located on the opposite side of the membrane attachment from the substrate. In some examples, an actuator may be located so as to exert a generally radial force on the membrane attachment and/or support structure, for example, exerting a force to urge the membrane attachment towards or away from the center of the lens.

In some examples, one or more actuators may be attached to respective actuator supports. In some examples, an actuator support may be attached to one or more actuators. For example, an actuator support may include an arcuate, circular, or other shaped member along which actuators are located at intervals. Actuator supports may be attached to the substrate, or, in some examples, to another device component such as a frame. In some examples, the actuator may be located between the membrane attachment and the substrate, or may be located at another suitable location. In some examples, the force exerted by the actuator may be generally directed along a direction normal to the substrate, or along another direction, such as along a direction at a non-normal direction relative to the substrate. In some examples, at least a component of the force may be generally parallel to the substrate. The path of the membrane attachment may be based on the guide path, and in some examples the force applied by the actuator may have at least an appreciable component directed along the guide path.

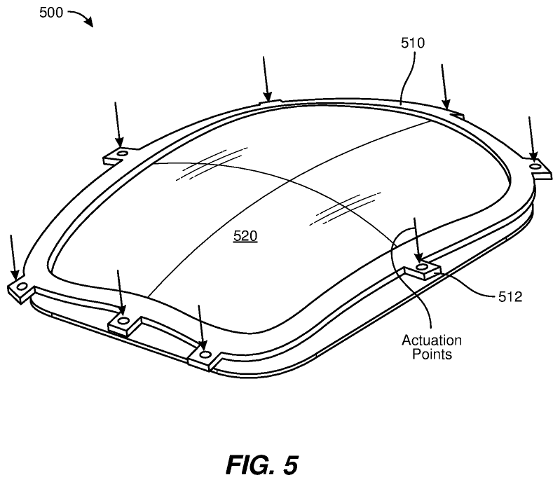

FIG. 5 shows an example fluid lens 500 including a peripheral structure 510, here in the form of the support ring including a plurality of membrane attachments 512, and extending around the periphery of a membrane 520. Membrane attachments may include one or more actuation points and optionally one or more hinge points. The membrane attachments may include or interact with one or more support structures that each provide a guide path for an associated control point of the membrane 520. Actuation of the fluid lens may adjust the location of one or more control points of the membrane, for example, along the guide paths provided by the support structures. Actuation may be applied at discrete points on the peripheral structure, such as the membrane attachments shown. In some examples, the peripheral structure may be flexible, for example, so that the peripheral structure may not be constrained to lie within a single plane.

In some examples, a fluid lens includes a membrane, a support structure, a substrate, and an edge seal. The support structure may be configured to provide a guide path for an edge portion of the membrane (such as a control point provided by a membrane attachment). An example membrane attachment may function as an interface device, configured to mechanically interconnect the membrane and the support structure, and may allow the membrane to exert an elastic force on the support structure. A membrane attachment may be configured to allow the control point of the membrane (that may be located in an edge portion of the membrane) to move freely along the guide path.

An adjustable fluid lens may be configured so that adjustment of the membrane profile (e.g., an adjustment of the membrane curvature) may result in no appreciable change in the elastic energy of the membrane, while allowing modification of an optical property of the lens (e.g., a focal length adjustment). This configuration may be termed a “zero-strain” device configuration as, in some examples, adjustment of at least one membrane edge portion, such as at least one control point, along a respective guide path does not appreciably change the strain energy of the membrane. In some examples, a “zero-strain” device configuration may reduce the actuation force required by an order of magnitude when compared with a conventional support beam type configuration. A conventional fluid lens may, for example, require an actuation force that is greater than 1N for an actuation distance of 1 mm. Using a “zero-strain” device configuration, actuation forces may be 0.1N or less for an actuation of 1 mm, for quasi-static actuation. This substantial reduction of actuation forces may enable the use of smaller, more speed-efficient actuators in fluid lenses, resulting in a more compact and efficient form factor. In such examples, in a “zero-strain” device configuration, the membrane may actually be under appreciable strain, but the total strain energy in the membrane may not change appreciably as the lens is adjusted. This may advantageously greatly reduce the force used to adjust the fluid lens.

In some examples, a fluid lens may be configured to have one or both of the following features: in some examples, the strain energy in the membrane is approximately equal for all actuation states; and in some examples, the force reaction at the membrane edge is normal to the guide path. Hence, in some examples, the strain energy of the membrane may be approximately independent of the optical power of the lens. In some examples, the force reaction at the membrane edge may be normal to the guide path for some or all locations on the guide path.

In some examples, movement of the edge portion of the membrane along the guide path may not result in an appreciable change in the elastic energy of the membrane. This configuration may be termed a “zero-strain” guide path as, in some examples, adjustment of the membrane edge portion along the guide path does not appreciably change the strain energy of the membrane.

In some examples, the fluid lenses of the present disclosure may be used as principal lenses in eyewear. As described herein, such lenses may be positioned in front of a user's eyes so the user looks through the lens at objects or images to be viewed, for example, when the user is wearing a head mounted device including one or more lenses. The lenses may be configured for vision correction or manipulation as described herein. Embodiments of the present disclosure may include fluid lenses including a lens fluid having a gas content, or reduced Henry law gas solubility, which may be controlled (e.g., reduced) to reduce the likelihood of bubble formation in the lens fluid.

FIG. 6 illustrates vergence-accommodation agreement in an eyewear device 600, such as a virtual reality device. The drawing is a horizontal-plane section view showing left and right waveguide displays, 610L and 610R respectively, and left and right adjustable fluid-filled lenses 602L and 602R, respectively. The element letter suffixes L and R are used to denote left and right elements, respectively. Each fluid lens, such as the right lens 602R, includes a membrane 620, a lens fluid 630, a side wall 640, and a substrate 650. The membrane, side wall, and substrate, at least in part, cooperatively provide an enclosure including the lens fluid 630. The waveguide displays 610L and 610R project stereoscopic virtual object 606 into the user's eyes, such as right eye 604. Rays of light from the waveguide displays are shown as solid lines, extending from the waveguide displays to the eyes, while virtual rays (i.e. the apparent direction the rays came from) are denoted by dashed lines. The figure also shows the vergence angle θᵥ, the corresponding vergence distance, the accommodation angle θₐ, and the accommodation distance.

The eyewear device 600 has properly adjusted fluid lenses 602L and 602R. The vergence distance and the accommodation distance to the virtual object 606 are approximately equal, and there is no vergence-accommodation conflict. In this example, the waveguide displays 610L, 610R output parallel rays of light that are defocused (diverged) by the corresponding negative power lenses 602L, 602R, respectively. The reduction of vergence-accommodation conflict (VAC) is very useful as this helps prevent possible VAC-related adverse effects on a user of the eyewear device, such as nausea, headaches, and the like. Examples of the present disclosure allow the reduction, substantial avoidance, or effective elimination of VAC, for example, using a negative optical power provided by the waveguide display assembly and/or the rear lens assembly.

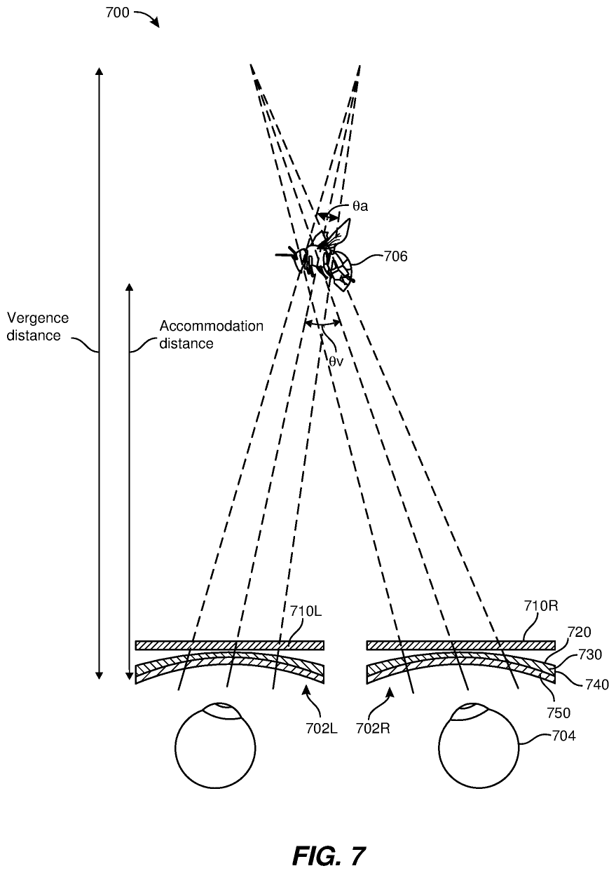

FIG. 7 shows an eyewear device 700 with left and right fluid lenses 702L and 702R (respectively) that are incorrectly adjusted so that the accommodation distance of the virtual object 706 does not match the vergence distance from stereoscopy, and in this example the accommodation distance is appreciably less than the vergence distance. In this configuration, the user may experience VAC discomfort. Each fluid lens includes a membrane 720, a side wall 740, and a substrate 750. The membrane, side wall, and substrate, at least in part, cooperatively provide an enclosure including the lens fluid 730. The waveguide displays 710L and 710R project stereoscopic virtual object 706 (e.g., an augmented reality image element) into the user's eyes, such as the right eye 704.

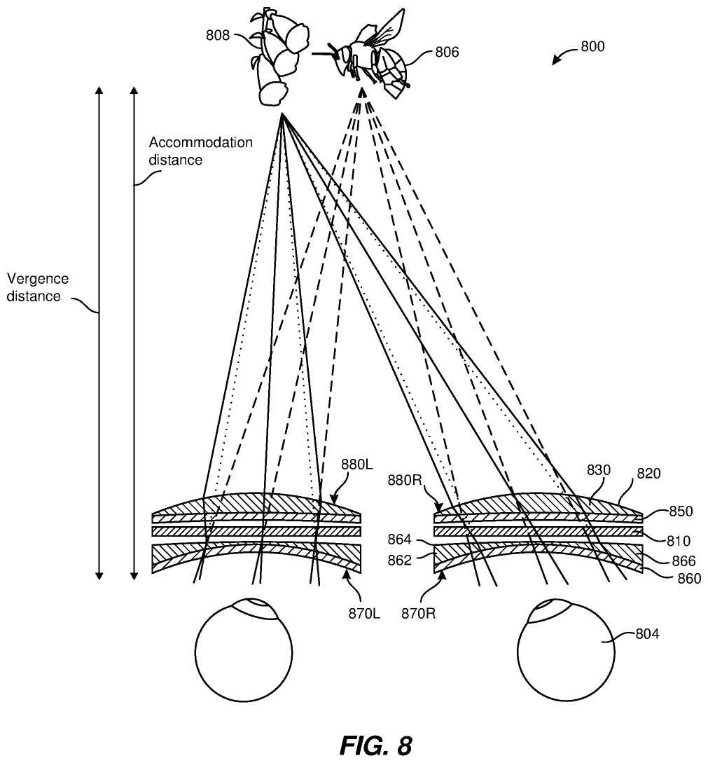

FIG. 8 shows a correctly adjusted eyewear device 800, for example, an augmented reality device. This device may be similar to the virtual reality device of FIG. 6. In addition to the eye-side adjustable lenses 870L and 870R for defocusing the light from waveguide displays 810L and 810R, the device includes front adjustable lenses 880L and 880R (e.g., front adjustable fluid lenses) to compensate for lenses 870L and 870R, for viewing real object 808 using the user's eyes, such as eye 804. In some examples, the optical power of 880L and 880R are equal and opposite to that of 870L and 870R. The optical power of an example front lens may be equal in magnitude to the optical power of a rear lens assembly (or to the optical power of the rear lens assembly in combination with the waveguide display assembly 810). For example, if lens 870R has an optical power of −2D, then lens 880R may have an optical power +2D. Rays of light from the real object 808 are shown as solid lines, and the virtual rays to the apparent position of virtual object 806 are shown as dashed lines. Each front adjustable lens may include a front membrane 820, front lens fluid 830, and front substrate 850. Each rear adjustable lens may include a rear substrate 860, rear side wall 862, rear membrane 864, and rear lens fluid 866. Front and rear lens assemblies may include front and rear adjustable lenses, respectively, and any desired associated component, such as a frame or component thereof, actuator, and/or the like. The waveguide display assembly 810 is located between the front and rear lens assemblies.

FIG. 9A shows a schematic of an example optical configuration, for example, for an augmented reality device. The device includes waveguide display 900, rear adjustable lens 920, and front adjustable lens 930. An optional second rear lens 910 may be included, here denoted with the subscript hhr. In this example, the optical configuration includes, from left to right, a first lens or substrate 926 (which may include a non-adjustable lens, such as a hard lens or other non-adjustable lens, or a substrate), rear adjustable lens 920, optional second rear lens 910 (which may be a non-adjustable lens, such as a hard lens or other non-adjustable lens), a waveguide display 900 including a grating 904, a front substrate 932 (which may have a curved or planar surface), and a front adjustable lens 930 (which may include the front substrate 932). Adjustable lenses may include fluid lenses, such as those discussed herein, which may include a substrate, a lens fluid, and a membrane. The membrane may provide an adjustable curved surface, for example, as shown at 924 and 934. These examples are for illustrative purposes only, and may be used to define the various symbols. The illustration is not to scale, and may be shown expanded the in the thickness and separation of the optical elements for clarity.

In this example, the adjustable lenses may have an adjustable optical surface denoted with subscript m for membrane (or adjustable surface), and a non-adjustable optical surface denoted with a subscript h for hard (or non-adjustable surface). As discussed further below, the subscripts m (membrane) and h (hard) may be combined with the subscripts f (front) and r (rear), and in some cases with subscripts 1 or 2, referring to first or second actuation states respectively. These subscripts may be used to label the optical power of the respective surface. In this context, the term “hard” may refer to a generally non-adjustable surface, or a surface for which any change in curvature may be reasonably neglected in the analysis. The optical power may be denoted ϕ, and may be given in diopters, sometimes abbreviated to “D”. The subscripts f and r relate to the front (world side) and rear (eye side) of the device, respectively. The subscript v refers to virtual content, and the subscripts 1 and 2 refer to first and second actuation states. In some examples, for illustrative purposes, a hard surface may be shown as having a slight lateral displacement between two actuation states, but the optical power of the surface may be unchanged. The subscript g refers to the optical power of an output grating on the waveguide display, and the grating optical power is denoted ϕ_{g}. Regarding the optical power associated with various curved surfaces, the rear non-adjustable surface 922 has an optical power Φₕᵣ, the rear adjustable surface 924 in a first actuation state has an optical power Φₘᵣ₁, the non-adjustable surface 912 of the optional second rear lens 910 has an optical power Φₕₕᵣ, the front non-adjustable surface of front substrate 932 has an optical power Φ_{hf}, and the front adjustable membrane surface 934 has an optical power Φ_{mf1} in a first actuation state. In this example, the front substrate 932 may have a planar surface, but in some examples, one or both planar surfaces of the front substrate 932 may be replaced by a curved surface (e.g., a non-adjustable or adjustable curved surface). In some examples, one or more of the illustrated non-adjustable surfaces may be replaced by adjustable surfaces, such as adjustable curved surfaces.

FIG. 9B shows the same optical configuration as FIG. 9A, with the rear and front adjustable lenses in their second actuation states. In the second actuation states, the optical power of the rear adjustable lens 920 is denoted by Φₘᵣ₂, and the optical power associated with the front adjustable membrane surface 934 (of front adjustable lens 930) is denoted by Φ_{mf2}. For conciseness, the front adjustable lens 930 may be referred to as the front lens, and the rear adjustable lens 920 may be referred to as the rear lens.

In some examples, the grating optical power may be non-adjustable, and may apply only to rays projected by the display; for example, ϕ_{g} may only affect the user's view of the virtual content, and not the real world.

The following equations may also be applied to the configuration illustrated in FIG. 9, or similar configurations, and may, for example, be adapted to other optical assemblies, including example optical assemblies with more, fewer, or different optical components.

In an example of zero net optical power, the real-world equations are:

Φₕᵣ+Φₘᵣ₁+Φₕₕᵣ+Φ_{hf}+Φ_{mf1}=0 (Equation 1)

Φₕᵣ+Φₘᵣ₂+Φₕₕᵣ+Φ_{hf}+Φ_{mf2}=0 (Equation 2)

Equations 1 and 2 do not include a term relating to grating power. Also, these equations may not apply in virtual reality devices, for example, in which there may be no real-world image.

The equivalent virtual-world equations are:

Φₕᵣ+Φₘᵣ₁+Φₕₕᵣ+Φ_{g}=Φᵥ₁ (Equation 3)

Φₕᵣ+Φₘᵣ₂+Φₕₕᵣ+Φ_{g}=Φᵥ₂ (Equation 4)

where ϕᵥ₁ and ϕᵥ₂ are the nearest and furthest virtual image projection powers, which may be predetermined, for example, by the optical design.

An example design may use Φᵥ₁=−3.5D and Φᵥ₂=−0.5D. This suggests that the virtual image may be in vergence-accommodation alignment between 29 cm and 2 m.

There are various possible design parameters, one or more of which may be used in the design of an optical configuration. An example design may include a minimum clearance between optical components (e.g., a minimum spacing between outside surfaces of adjacent components). For example, a design may include a condition that there is at least approximately 0.1 mm clearance between components. An example design may include a minimum thickness for any substrate, such as a non-adjustable substrate, or a non-adjustable lens. For example, a substrate may be at least approximately 0.5 mm thick. In some examples, a waveguide display may have a thickness of at least 1 mm, such as approximately 1.5 mm.

An example design may use spherical or non-spherical optics. In some examples, the lens fluid may include pentaphenyl trimethyl trisiloxane, which may have a refractive index of approximately 1.59, and a density of approximately 1.09 g/cc, under typical operating conditions.

FIG. 10 shows an example design eyeshape (in a solid line), with the optical center at the origin of the coordinate system shown. A consequence of the eyeshape and optical center is the size and location of the neutral circle (radius rₙ) shown as a dashed line in FIG. 10. For spherical optics, the neutral circle represents an intersection of the various membrane surface profiles for different actuation states, given the requirement of volume conservation from the incompressibility of the lens fluid. For example, with regard to the examples discussed above in relation to FIG. 9A, the membrane may intersect the neutral circle in the first and second actuation states 1 and 2, and between these locations at intermediate states.

In some examples, a device includes an optical configuration similar to that shown in FIG. 9A, but with the optional second rear lens 910 omitted. Equations 1-4, discussed above, may then be applied to this optical configuration, with ϕₕₕᵣ=0. Example design parameters may include a positive membrane curvature so that the pressure of the lens fluid is above atmospheric pressure. A minimum membrane curvature of +0.5D was chosen for evaluation. The positive pressure applied to the lens fluid may inhibit bubble formation. Also, having no curvature sign change during adjustment of a fluid lens may facilitate single-sided control of the membrane and may help reduce eye-obscuring specular reflections associated with a planar membrane state. For example, a planar membrane state may occur as a fluid lens is adjusted between positive (convex) and negative (concave) membrane configurations, for example, if the substrate is planar. In some examples, the fluid lens may not be integrated with the display.

In some examples, the grating optical power may be non-adjustable and may apply only to rays projected by the waveguide display. For example, the grating optical power (ϕ_{g}) may only affect the user's view of the virtual content (which may include augmented reality image elements) and not the real-world image.

FIG. 11 shows a surface plot of an augmented reality lens configuration, for example, using a configuration according to examples discussed above in relation to FIGS. 9A-10. The lens configuration may include a rear lens 920, waveguide display 900, and front lens 930. In this example, the front lens 930 may have a non-adjustable surface provided by substrate 932 and an adjustable surface provided by membrane 934. The lens configuration includes zero optical power for the waveguide display (ϕ_{g}=0). Surface profiles are illustrated and denoted with the optical power labels discussed above in relation to FIGS. 9A and 9B. Regarding the membrane profiles of adjustable lenses having first and second states, these profiles intersect at the neutral circle. The surface optical power terms, as used in equations 1 to 4, are used to label the various surface profiles shown in the figure. In this example, the lens configuration thickness may be approximately 9 mm, and the fluid mass (e.g., of silicone oil) may be 5.4 g.

In FIG. 11, the optical power, ϕ, of the various surfaces is given in diopters, sometimes abbreviated to “D”, and the subscripts f and r related to the front (world side) and rear (eye side) of the device, respectively. The subscript v refers to virtual content, and the subscripts 1 and 2 refer to first and second actuation states, for example, of a fluid lens. The figure shows surface optical powers for the rear adjustable lens (920), waveguide display (900), and the front adjustable lens (930), sometimes referred to as the “front lens”, where the element numbers relate to an optical configuration similar to that shown in FIG. 9A. The illustrated optical powers relate to the rear non-adjustable surface of the rear fluid lens (Φₕᵣ), the membrane surface of the rear fluid lens in the first (Φₘᵣ₁) and second (Φₘᵣ₂) actuation states, the waveguide display (ϕ_{g}), the non-adjustable surface of the front fluid lens (Φ_{hf}), and the membrane of the front fluid lens in the first (Φ_{mf1}) and the second (Φ_{mf2}) actuation states of the front fluid lens. In this example, the non-adjustable surface of the front fluid lens planar, but in some examples this may be replaced by a non-adjustable (or adjustable) curved surface. In some examples, one or more of the illustrated non-adjustable surfaces may be replaced by adjustable surfaces, such as adjustable curved surfaces. In some examples, the orientation of the front fluid lens may be reversed, so that the non-adjustable surface is the exterior surface.

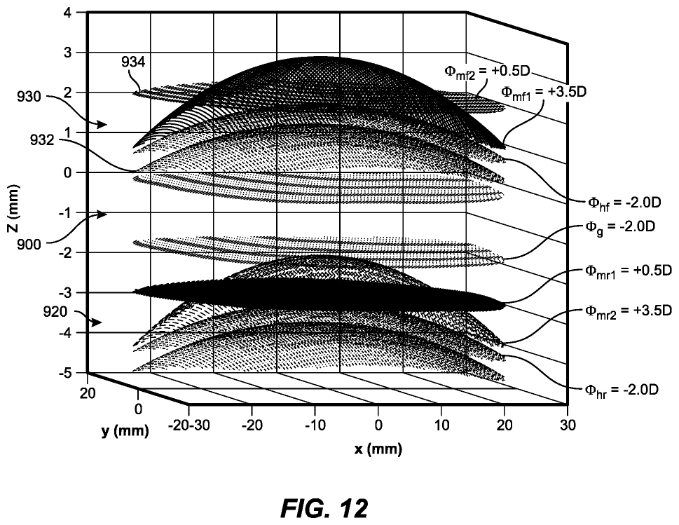

FIG. 12 shows a similar lens system to that discussed above, in relation to FIG. 11. As discussed above in relation to FIG. 11, the lens system may include a rear lens 920, waveguide display 900, and front lens 930. The front lens 930 may have a non-adjustable surface provided by substrate 932 and an adjustable surface provided by membrane 934. However, in this example, the waveguide display has an output grating power of −2.0 D. The curvature of the rear substrate is changed (relative to the example of FIG. 11) from −4.0D to −2.0D, and the front substrate curvature is changed from 0D to −2.0D. In this example, the lens configuration thickness may be reduced to approximately 8 mm, and the fluid mass may be reduced to 3.2 g. The reductions in thickness and mass are in relation to the configuration discussed above in relation to FIG. 11.

The introduction of an optical power associated with the waveguide display (e.g., a grating optical power), in the example optical configuration of FIG. 12, allows one or more of various improvements, such as one or more of the following: an appreciable reduction in mass, an appreciable reduction in the thickness of the optical configuration, an appreciable increase in the response time of the fluid lens, and/or a reduction in complexity of manufacture (e.g., by allowing the substrates of the front and rear fluid lenses to be substantially identical). The example improvements determined for the modeled system of FIG. 12 include the following: the mass of the lens system decreased by 2.2 g (as the change in the mass of the substrates is negligible compared to the change in the mass due to reducing the fluid volume); the packaging thickness decreased by 1.1 mm; and the minimum center thickness of the rear adjustable lens increased, which may appreciably improve the response time. Also, in this example configuration, the front and rear lenses may be identical, which improves the efficiency of device manufacture. Hence, there are numerous various advantages available by introducing a grating optical power to the optical configuration.

FIGS. 13A and 13B show plots of overall optical assembly thickness (FIG. 13A) and fluid mass (FIG. 13B) as functions of grating power (ϕ_{g} in diopters). The figures identify a range of grating powers over which thickness and weight are minimized or appreciably reduced. For example, the thickness and the fluid mass are at their lowest values for a grating optical power over a range of −1.6 D to −2.4 D. However, there are other grating optical power ranges over which improved device parameters may be obtained, compared with devices having a grating optical power outside of that range (e.g., in comparison with a zero grating power, φ_{g}=0). Example ranges (in diopters) include, without limitation, the ranges −1.5 to −2.5, −1.4 to −2.6, −1.3 to −2.7, −1.2 to −2.8. −1.1 to −2.9, −1 to −3, −0.5 to −3.5, and −0.1 to −3.9. Other possible ranges are apparent from the figures, such as −0.8 to −3.2. For example, the sum of the range limits may be approximately −4, and the range limits of the grating power may be in the form (−1.6+x) to (−2.4−x), where x may be a positive value, such as a multiple of 0.1, for example, up a value up to 1.5. In some examples, the grating optical power may be approximately −2, and the range limits and the range limits of the grating power may be in the form (−2+x) to (−2−x), where x may be a positive value, such as a multiple of 0.1 of 1.9 or less.

In some examples, such as using a different optical configuration, the grating optical power may be approximately −A and the range limits of the grating optical power may be in the form (−A+x) to (−A−x), where x may be a positive value, such as a multiple of 0.1, up to a value, such as (A−0.1).

In some examples, the membrane curvature (or the fluid pressure) may be negative or positive. In some examples, a device may be configured so that the membrane curvature does not pass through a planar state, which may also be termed a zero diopter (0 D) state. This may facilitate control of the membrane and may reduce specular reflections from the planar membrane surface. In some examples, the rear membrane curvature may be adjusted between +0.5D and +3.5D. In some examples, the grating optical power may be a negative value.

In some examples, the one or more membranes are not exposed, for example, to mechanical disturbances from outside the device. In some examples, a device may include a front element that also provides protection to the device, such as the non-adjustable substrate of a fluid lens, a non-adjustable lens (which may also be termed a fixed lens), or a window, or similar. One or more element surface of a device may have an antireflective surface and/or a scratch-resistant surface. In some examples, one or more fluid lenses (including, for example, a membrane and a substrate), may be configured so that the membrane faces inwards and the substrate faces outwards. For example, in relation to the optical configuration of FIG. 9A, the orientation of the front adjustable lens 930 may be reversed so that the membrane 934 is on the left (as illustrated), so that the membrane side of the lens faces the waveguide display 902, and the front substrate 932 is on the right (as illustrated). The substrate may provide an exterior surface for the device, such as an outer surface for an optical configuration of an eyewear device. The substrate may also be curved, having one or two curved surfaces, as discussed further below.

In some examples, the radius of curvature of the front element, such as the radius of curvature of the substrate of a fluid lens, or the outer surface of a fixed lens, may be fixed. The outer front surface may, for example, have a radius of curvature (sometimes referred to herein more concisely as “curvature”) in the range of 50 mm-250 mm, such as 100 mm-200 mm, for example, 125 mm-175 mm, for example, approximately 145 mm. This may be an aesthetic decision, for example, as a moving outer optical surface may be undesirable to consumers, and this curvature may be similar to the curvature of typical eyeglasses (e.g., approximately 3.5D for a refractive index of 1.5).

In some examples, an optical configuration may be similar to that shown in FIG. 9A, but the optional second rear (non-adjustable) lens 910 may be omitted.

In some examples, a fluid lens, such as the front fluid lens (e.g., front adjustable lens 930 of FIG. 9A), may be integrated with the waveguide display (e.g., waveguide display 900 of FIG. 9A). For example, the grating structure may provide a substrate for the fluid lens (e.g., the front substrate 932 of FIG. 9A may be omitted and the substrate of the front lens may be provided by the waveguide display 900). In some examples, the waveguide display may provide a substrate having a curved interface with the lens fluid. However, in some examples, the fluid lens and the waveguide display may be separate components.

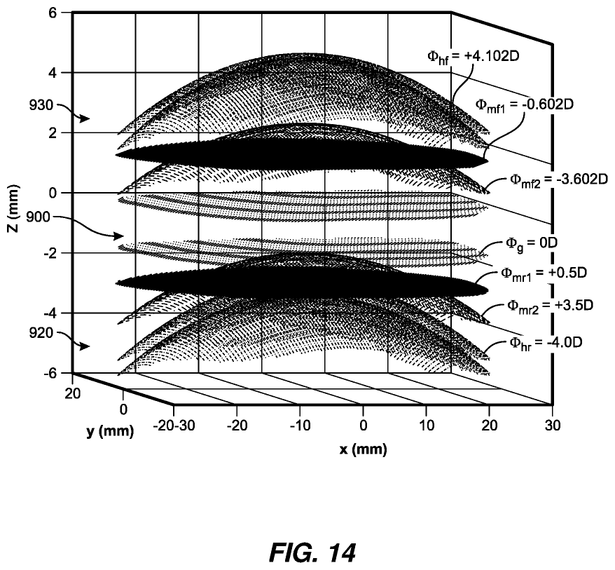

FIG. 14 shows an optical configuration in which the waveguide display has zero optical power. The representations of curved surfaces are labeled with the associated optical powers, using the terminology introduced above in relation to the surfaces illustrated in FIG. 9A. The optical configuration may include a waveguide display 900, rear adjustable lens 920, and front adjustable lens 930 (e.g., as shown in FIG. 9A). FIG. 14 uses a similar labeling scheme to that of FIG. 9A. In this example, ϕ_{g}=0, the lens thickness may be approximately 11 mm, and the fluid mass may be 5.4 g.

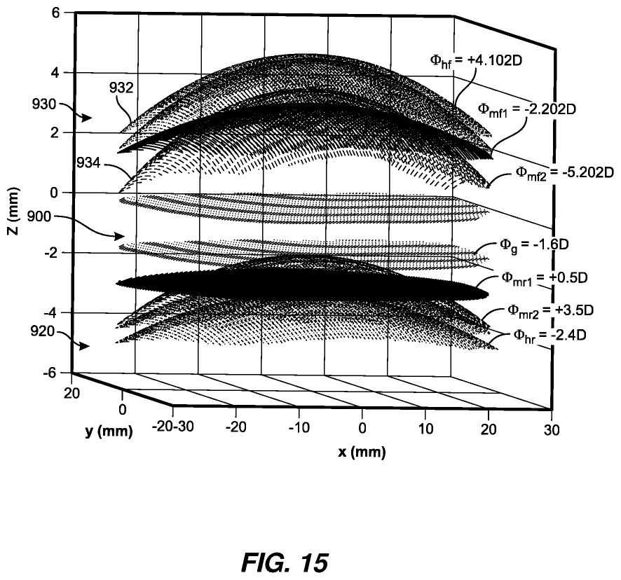

FIG. 15 shows an optical configuration having a grating optical power of ϕ_{g}=−1.6 D. The representations of curved surfaces are labeled with the associated optical powers, using the terminology introduced in relation to FIG. 9A, and are similar to that of FIG. 14 discussed above. In this example, the thickness may be reduced to approximately 10 mm, and the fluid mass may be reduced to 3.2 g, relative to the configuration of FIG. 14. Hence, the inclusion of negative grating power allows the thickness and/or mass of the optical assembly to be reduced.

FIGS. 16A and 16B show plots of overall thickness (FIG. 16A) and fluid mass (FIG. 16B) as functions of grating power (ϕ_{g} in diopters). The figures identify a range of grating powers over which thickness and weight are minimized, or appreciably reduced. For example, the thickness and the fluid mass are at their lowest values for a grating optical power over a range of −1.6 D to −2.4 D. However, there are other grating optical power ranges over which improved device parameters may be obtained, compared with devices having a grating optical power outside of that range, and these ranges may be similar to those discussed above in relation to FIGS. 13A and 13B.

FIG. 17 illustrates an example method 1700 of operating a device, such as a method of using an augmented reality device. The method may include: providing an optical configuration which includes a front lens assembly, a waveguide display assembly, and a rear lens assembly (1710); providing a real-world image (e.g., to a user) using real-world light that passes through the front lens assembly, the waveguide display assembly, and the rear lens assembly (1720); and generating an augmented reality image using augmented reality light provided (e.g., to the user) by the waveguide display assembly and which passes through the rear lens assembly (1730). In some examples, the grating assembly both provides the augmented reality image and provides a negative optical power for the real-world and/or augmented reality light.

In some examples, the front lens assembly may include a fluid lens having a membrane (having positive curvature) and a substrate (having negative curvature), the rear lens assembly may include a fluid lens having a membrane (e.g., having a positive or convex exterior surface curvature) and a substrate (having negative curvature), and the grating assembly may include a surface having a negative curvature. In some examples, the substrate of a fluid lens, such as a rear fluid lens, may have a concave exterior surface and the substrate may provide a negative optical power. In this context, an exterior surface may face outwards from the lens and may be substantially adjacent air. In some examples, the front lens assembly may have a positive optical power. In some examples, the positive optical power of the front lens assembly may be approximately equal to the negative optical power of the waveguide display assembly in combination with the rear lens assembly.

In some examples, a device may include an augmented or virtual reality device having a waveguide display in front of each of a user's eyes and one or more adjustable lenses per eye. The adjustable lenses may be adjusted for one or more of the following purposes: providing improved focus for the eyes, distance or close viewing, or for correcting vergence accommodation conflict. One or more of the adjustable lenses may be a fluid filled lens. An additional eye-side optical element may be provided that defocuses light from the display so that the adjustable lens or lenses may be thinner and lighter and may have a faster response time. The additional eye-side optical element may include a refractive lens and/or may be provided as an optical power on the output grating of a waveguide type display.

Example embodiments of the present disclosure include devices with reduced or substantially eliminated vergence-accommodation conflict, including thin, light and low power devices. Device design may include reduction or minimization of thickness, weight, or response time. In some examples, the response time of a fluid lens may be traded for thickness and/or weight.

In some examples, a device includes an optical configuration including a front lens assembly, a waveguide display assembly, and a rear lens assembly. The waveguide display assembly may be configured to provide augmented reality image elements within a real-world image and may be located between the front lens assembly and the rear lens assembly. In some examples, the waveguide display assembly includes an element having a negative optical power for augmented reality light provided by the waveguide display assembly. The front lens assembly may receive real-world light used to form a real world image. Real-world light may enter and pass through the front lens assembly, pass through the waveguide display assembly, and then pass through the rear lens assembly to reach the eye of a user when the user wears the device.

In this context, the term “front” may refer to the word-side of the waveguide display assembly and the term “rear” may refer to the eye-side of the waveguide display, during normal use of a device. The front lens assembly may include a front adjustable lens, such as a front fluid lens. The rear lens assembly may include a rear adjustable lens, such as a rear fluid lens. The front and/or rear lens assemblies may further include lens control components, such as one or more actuators, eye ring, or other component. An arrangement of optical elements, such as distensible membranes, hard lenses, diffractive elements, waveguide displays, or other optical elements, may be termed a sequence of optical elements. A fluid lens with the membrane forward of the substrate (relative to a user's eye) may represent a different sequence from a fluid lens with the lens at the front and the membrane rearwards, and both may have the same range of optical powers.

In some examples, the front adjustable lens includes a front fluid lens, which may include a front substrate, a front membrane, and a front lens fluid located between the front substrate and the front membrane. The rear adjustable lens may include a rear fluid lens, which may include a rear substrate, a rear membrane, and a rear lens fluid located between the rear substrate and the rear membrane. In some examples, the front substrate may have a front concave profile and an associated front negative optical power. In some examples, the rear substrate may have a rear concave profile, and an associated rear negative optical power. The front negative optical power may be approximately equal to the rear negative optical power.

In some examples, the real-world image may be formed by real-world light passing through the front lens assembly, at least a portion of the waveguide display assembly, and the rear lens assembly.

In some examples, augmented reality light may be provided by the waveguide display assembly. The waveguide display assembly may include a waveguide display. The waveguide display may include out-coupling components configured to couple light out of the waveguide display and towards the eye of the user. The out-coupling components may include a grating.

The waveguide display assembly may have a negative optical power, for example, for the augmented reality light. In some examples, the waveguide display assembly may include a waveguide display and a negative lens (the negative lens having a negative optical power). The negative lens may be located between the waveguide display and the rear lens assembly. The waveguide display assembly and/or the rear lens assembly may include a supplemental negative lens (e.g., a plano-concave lens, or a biconcave lens).

In some examples, the waveguide display may be configured to out-couple diverging light from the waveguide display. In some examples, the grating output surface may have a spatially variable blaze angle.

In some examples, the waveguide display may include one or more curved surfaces configured to diverge augmented reality light coupled out from the waveguide display by the grating. In some examples, the grating may be disposed on a curved surface, such as a parabolic or spherical surface. In some examples, one or more reflectors, for example, on an opposed surface of the waveguide display, may be either curved or arranged over a curved surface.

In some examples, a device may be (or include) an eyewear device configured to be worn by a user. The device may be configured to provide a real-world image, where real-world light forming the real-world image passes through the front lens assembly, the waveguide display assembly, and the rear lens assembly, and an augmented reality image, where the augmented reality image is provided by the waveguide display assembly and passes through the rear lens assembly. The rear lens assembly may include a rear adjustable fluid lens.

In some examples, the device may further include a support, such as a frame configured to support the lens configuration, one or more straps, or other suitable support (e.g., to support the device on the head of a user). The device may include an eyewear device. The device may include an augmented reality headset.

In some examples, the device is configured so that the waveguide display assembly has a negative optical power and the negative optical power corrects for vergence-accommodation conflict between the real-world image and the augmented reality image.

In some examples, a method includes providing an optical configuration, where the optical configuration includes a front lens assembly, a waveguide display assembly, and a rear lens assembly, providing a real-world image using real-world light that passes through the front lens assembly, the waveguide display assembly, and the rear lens assembly, and generating an augmented reality image using augmented reality light provided by the waveguide display assembly. The augmented reality light may pass through the rear lens assembly. The waveguide display assembly may provide the augmented reality image, and may also provide a negative optical power for the augmented reality light. The display assembly may provide the augmented reality image by receiving augmented reality light from an augmented reality light source and coupling the augmented reality light into the light path using a grating, where the waveguide display assembly provides a negative optical power for the augmented reality light. In some examples, the waveguide display assembly provides diverging augmented reality light. The method may also include a method of operating an augmented reality device.

Examples disclosed herein may include fluid lenses, membrane assemblies (that may include a membrane and, e.g., a peripheral structure such as a support ring or a peripheral wire), and devices including one or more fluid lenses. Example devices may include ophthalmic devices (e.g., spectacles), augmented reality devices, virtual reality devices, and the like. In some examples, a device may include a fluid lens configured as a primary lens of an optical device, for example, as the primary lens for light entering the user's eye.

In some examples, a fluid lens may include a peripheral structure, such as a support ring, or a peripheral wire. A peripheral structure may include a support member affixed to the perimeter of a distensible membrane in a fluid lens. The peripheral structure may have generally the same shape as the lens periphery. In some examples, non-round fluid lens may include a peripheral structure that may bend normally to a plane, for example, a plane corresponding to the membrane periphery for a round lens. The peripheral structure may also bend tangentially to the membrane periphery.

A fluid lens may include a membrane, such as a distensible membrane. A membrane may include a thin sheet or film (having a thickness less than its width or height). The membrane may provide the deformable optical surface of an adjustable fluid lens. The membrane may be under a line tension, that may be the surface tension of the membrane. Membrane tension may be expressed in units of N/m.

In some examples, a device includes a membrane, a support structure configured to provide a guide path for an edge portion of the membrane, an interface device which connects the membrane, or a peripheral structure disposed around the periphery of the membrane, to the support structure and allows the membrane to move freely along the guide path, a substrate, and an edge seal. In some examples, the support structure may be rigid, or semi-rigid.

In some examples, an adjustable fluid lens may include a membrane assembly. A membrane assembly may include a membrane (e.g., having a line tension), and a wire or other structure extending around the membrane (e.g., a peripheral guide wire). A fluid lens may include a membrane assembly, a substrate, and an edge seal. In some examples, the membrane line tension may be supported by a support ring. This may be augmented by a static restraint and/or a hinge point at one or more locations on the support ring.

In some examples, a fluid lens may include a membrane, a support structure configured to provide a guide path for an edge portion of the membrane, and a substrate. The fluid lens may further include an interface device, configured to connect the membrane to the support structure and to allow the edge portion of the membrane to move freely along the guide path, a substrate, and an edge seal. In some examples, fluid lenses may include lenses having an elastomeric or otherwise deformable element (such as a membrane), a substrate, and a fluid. In some examples, movement of a control point of the membrane, for example, as determined by the movement of a membrane attachment along a guide path, may be used to adjust the optical properties of a fluid lens.

Example embodiments include apparatus, systems, and methods related to fluid lenses. In some examples, the term “fluid lens” may include adjustable fluid-filled lenses, such as adjustable liquid-filed lenses.

In some examples, a fluid lens, such as an adjustable fluid lens, may include a pre-strained flexible membrane which at least partially encloses a fluid volume, a fluid enclosed within the fluid volume, and a flexible edge seal which defines a periphery of the fluid volume, and an actuation system configured to control the edge of the membrane such that the optical power of the lens can be modified. The fluid volume may be referred to as an enclosure.

Controlling the edge of the membrane may require energy to deform the membrane, and/or energy to deform a peripheral structure such as a support ring, or a wire (e.g., in the case of a non-round lens). In some examples, a fluid lens configuration may be configured to reduce the energy required to change the power of the lens to a low value, for example, such that the change in elastic energy stored in the membrane as the lens properties change may be less than the energy required to overcome, for example, frictional forces.

In some examples, an adjustable focus fluid lens includes a substrate and an membrane (e.g., an elastic membrane), where a lens fluid is retained between the membrane and the substrate. The membrane may be under tension, and a mechanical system for applying or retaining the tension in the membrane at sections may be provided along the membrane edge or at portions thereof. The mechanical system may allow the position of the sections to be controllably changed in both height and radial distance. In this context, height may refer to a distance from the substrate, along a direction normal to the local substrate surface. In some examples, height may refer to the distance from a plane extending through the optical center of the lens and perpendicular to the optic axis. Radial distance may refer to a distance from a center of the lens, in some examples, a distance from the optical axis along a direction normal to the optical axis. In some examples, changing the height of at least one of the sections restraining the membrane may cause a change in the membrane's curvature, and the radial distance of the restraint may be changed to reduce increases in the membrane tension.

In some examples, a mechanical system may include a sliding mechanism, a rolling mechanism, a flexure mechanism, or an active mechanical system, or a combination thereof. In some examples, a mechanical system may include one or more actuators, and the one or more actuators may be configured to control both (or either of) the height and/or radial distance of one or more of the sections.

An adjustable focus fluid lens may include a substrate, a membrane that is in tension, a fluid, and a peripheral structure restraining the membrane tension, where the peripheral structure extends around a periphery of the membrane, and where, in some examples, the length of the peripheral structure and/or the spatial configuration of the peripheral structure may be controlled. Controlling the circumference of the membrane may controllably maintain the membrane tension when the optical power of the fluid lens is changed.

Changing the optical power of the lens from a first power to a second power may cause a first change in membrane tension if the membrane circumference does not change. However, changing the membrane circumference may allow a change in the membrane tension of approximately zero, or at least +/−1%, 2%, 3%, or 5%. In some examples, a load offset or a negative spring force may be applied to the actuator.

One or more components of a fluid lens may have strain energy within some or all operational configurations. In some examples, a fluid lens may include an elastomer membrane that may have strain energy if it is stretched. Work done by an external force, such as provided by an actuator when adjusting the membrane, may lead to an increase in the strain energy stored within the membrane. In some examples, one or more edge portions of the membrane are adjusted along a guide path such that the strain energy stored within the membrane may not be significantly changed, or changed by a reduced amount.

A force, such as a force provided by an actuator, may perform work when there is a displacement of the point of application in the direction of the force. In some examples, a fluid lens is configured so that there is no appreciable elastic force in the direction of the guide path. In such configurations, a displacement of the edge portion of the membrane along the guide path may not require work in relation to the elastic force. There may, however, be work required to overcome friction and other relatively minor effects.

In some examples, a fluid lens includes a support ring. A support ring may include a member affixed to a perimeter of a distensible membrane in a fluid lens. The support ring may be approximately the same shape as the lens. For a circular lens, the support ring may be generally circular for spherical optics. For non-circular lenses, the support ring may bend normally to the plane defined by the membrane. However, a rigid support ring may impose restrictions on the positional adjustment of control points, and in some examples a wire is positioned around the periphery of the membrane. In some examples, a support ring may allow flexure out of the plane of the ring. In some examples, a support ring (or peripheral wire) may not be circular.

In some examples, a fluid lens may include one or more membranes. An example membrane may include a thin polymer film, having a membrane thickness much less than the lens radius, or other lateral extent of the lens. For example, the membrane thickness may be less than approximately 1 mm. The lateral extent of the lens may be at least approximately 10 mm. The membrane may provide the deformable optical surface of a fluid lens, such as an adjustable liquid-filled lens. A fluid lens may also include a substrate. The substrate may have opposed surfaces, and one surface of the substrate may provide one lens surface of an adjustable fluid lens, opposite the lens surface provided by the membrane. An example substrate may include a rigid layer, such as a rigid polymer layer, or a rigid lens. In some examples, one or more actuators may be used to control the line tension of a distensible membrane, where line tension may be expressed in units of N/m. A substrate may include a rigid polymer, such as a rigid optical polymer. In some examples, a fluid lens may include an edge seal, for example, a deformable component, such as a polymer film, configured to retain the fluid in the lens. The edge seal may connect a peripheral portion of the membrane to a peripheral portion of the substrate, and may include a thin flexible polymer film.

In some examples, a membrane may include one or more control points. Control points may include locations proximate the periphery of the membrane, movement of that may be used to control one or more optical properties of a fluid lens. In some examples, the movement of the control point may be determined by the movement of a membrane attachment along a trajectory (or guide path) determined by a support structure. In some examples, a control point may be provided by an actuation point, for example, a location on a peripheral structure, such as a membrane attachment, that may have a position adjusted by an actuator. In some examples, an actuation point may have a position (e.g., relative to the substrate) controlled by a mechanical coupling to an actuator. A membrane attachment may mechanically interact with a support structure, and may be, for example, moveable along a trajectory (or guide path) determined by the support structure (e.g., by a slot or other guide structure). Control points may include locations within an edge portion of a membrane that may be moved, for example, using an actuator, or other mechanism. In some examples, an actuator may be used to move a membrane attachment (and, e.g., a corresponding control point) along a guide path provided by a support structure, for example, to adjust one or more optical properties of the fluid lens. In some examples, a membrane attachment may be hingedly connected to a support structure at one or more locations, optionally in addition to other types of connections. A hinged connection between the membrane and a support structure may be referred to as a hinge point.

A fluid lens may be configured to have one or both of the following features: in some examples, the strain energy in the membrane is approximately equal for all actuation states; and in some examples, the force reaction at membrane edge is normal to the guide path. Hence, in some examples, the strain energy of the membrane may be approximately independent of the optical power of the lens. In some examples, the force reaction at the membrane edge is normal to the guide path, for some or all locations on the guide path.

In some examples, a guide path may be provided by a support structure including one or more of the following: a pivot, a flexure, a slide, a guide slot, a guide surface, a guide channel, a hinge, or other mechanism. A support structure may be entirely outside the fluid volume, entirely inside the fluid volume, or partially within the fluid volume.

In some examples, a fluid lens (that may also be termed a fluid-filled lens) may include a relatively rigid substrate and a flexible polymer membrane. The membrane may be attached to a support structure at control points around the membrane periphery. A flexible edge seal may be used to enclose the fluid. The lens power can be adjusted by moving the location of control points along guide trajectories, for example, using one more actuators. Guide paths (that may correspond to allowed trajectories of control points) may be determined that maintain a constant elastic deformation energy of the membrane as the control point location is moved along the guide path. Guide devices may be attached to (or formed as part of) the substrate.

Sources of elastic energy include hoop stress (tension in azimuth) and line strain, and elastic energy may be exchanged between these as the membrane is adjusted. In some examples, the force direction used to adjust the control point location may be normal to the elastic force on the support structure from the membrane. There are great possible advantages to this approach, including much reduced actuator size and power requirements, and a faster lens response that may be restricted only by viscous and friction effects.

In some examples, one or more optical parameters of a fluid lens may be determined at least in part by a physical profile of a membrane. In some examples, a fluid lens may be configured so that one or more optical parameters of the lens may be adjusted without significant change in the elastic strain energy in the membrane. For example, the elastic strain energy in the membrane may change by less than 20% as the lens is adjusted. In some examples, one or more optical parameters of the lens may be adjusted using an adjustment force, for example, a force applied by an actuator, that is normal to a direction of an elastic strain force in the membrane. In some examples, a guide path may be configured so that the adjustment force may be at least approximately normal to the elastic strain force during adjustment of the lens. For example, the angle between the adjustment force and the elastic strain force may be within 5 degrees of normal, for example, within 3 degrees of normal. In some examples, fluid motion during an adjustment of the lens may induce a reduction in the viscosity of the fluid, for example, the flow may disrupt interactions between particles or molecules within the fluid, which may disrupt particle and/or molecular aggregation.

In some examples, a fluid lens includes a fluid, a substrate, and a membrane, with the substrate and the membrane at least partially enclosing the fluid. The fluid within a fluid lens may be referred to as a “lens fluid” or occasionally as a “fluid” for conciseness. The lens fluid may include a liquid, such as an oil, such as a silicone oil, such as a phenylated silicone oil. In some examples, a lens fluid may include a polyphenylether (PPE). In some examples, a lens fluid may include a polyphenylthioether.

In some examples, a lens fluid may be (or include) a transparent fluid. In this context, a transparent fluid may have little or substantially no visually perceptible visible wavelength absorption over an operational wavelength range. However, fluid lenses may also be used in the UV (ultraviolet) and the IR (infrared), and in some examples the fluid used may be generally non-absorbing in the wavelength range of the desired application, and may not be transparent over some or all of the visible wavelength range. In some examples, the membrane may be transparent, for example, optically clear at visible wavelengths.

In some examples, a lens fluid may include an oil, such as an optical oil. In some examples, a lens fluid may include one or more of a silicone, a thiol, or a cyano compound. The fluid may include a silicone based fluid, that may sometimes be referred to as a silicone oil. Example lens fluids include aromatic silicones, such as phenylated siloxanes, for example, pentaphenyl trimethyl trisiloxane. Example lens fluids may include a phenyl ether or phenyl thioether. Example lens fluids may include molecules including a plurality of aromatic rings, such as a polyphenyl compound (e.g., a polyphenyl ether or a polyphenyl thioether).

In some examples, a fluid lens includes, for example, a membrane at least partially enclosing a fluid. A fluid may be, or include, one or more of the following: a gas, gel, liquid, suspension, emulsion, vesicle, micelle, colloid, liquid crystal, or other flowable or otherwise deformable phase. For example, a fluid may include a colloidal suspension of particles, such as nanoparticles.

In some examples, a lens fluid may have a visually perceptible color or absorption, for example, for eye protection use or improvement in visual acuity. In some examples, the lens fluid may have a UV absorbing dye and/or a blue absorbing dye, and the fluid lens may have a slightly yellowish tint. In some examples, a lens fluid may include a dye selected to absorb specific wavelengths, for example, laser wavelengths in the example of laser goggles. In some examples, a device including a fluid lens may be configured as sunglasses, and the lens fluid may include an optical absorber and/or photochromic material. In some examples, a fluid lens may include a separate layer, such as a light absorption layer configured to reduce the light intensity passed to the eye, or protect the eye against specific wavelengths or wavelength bands. Reduced bubble formation may greatly enhance the effectiveness of laser protection devices, by reducing scattering of the laser radiation, and reduction of low-absorption portions of the device.

A fluid lens may include a deformable element such as a polymer membrane, or other deformable element. A polymer membrane may be an elastomer polymer membrane. Membrane thicknesses may be in the range 1 micron-1 mm, such as between 3 microns-500 microns, for example, between 5 microns and 100 microns. An example membrane may be more of the following: flexible, optically transparent, water impermeable, and/or elastomeric. A membrane may include one or more elastomers, such as one or more thermoplastic elastomers. A membrane may include one or more polymers, such as one or more of the following: a polyurethane (such as a thermoplastic polyurethane (TPU), a thermoplastic aromatic polyurethane, an aromatic polyether polyurethane, and/or a cross-linked urethane polymer), a silicone elastomer such as a polydimethylsiloxane, a polyolefin, a polycycloaliphatic polymer, a polyether, a polyester (e.g., polyethylene terephthalate), a polyimide, a vinyl polymer (e.g., a polyvinylidene chloride), a polysulfone, a polythiourethane, polymers of cycloolefins and aliphatic or alicyclic polyethers, a fluoropolymer (e.g., polyvinylfluoride), another suitable polymer, and/or a blend, derivative, or analog of one or more such polymers. The membrane may be an elastomer membrane, and the membrane may include one or more elastomers.

In some examples, at least part of the interior surface of the enclosure may have a coating that reduces, substantially eliminates, or in some examples, greatly increases the number of nucleation sites for formation of bubbles in the lens fluid. The coating may be located between the lens fluid and the interior surface of the enclosure (that may include interior surfaces of the membrane and/or substrate). In some examples, the coating may prevent the lens fluid, such as an optical oil, from penetrating the membrane, which may otherwise degrade the optical and/or physical properties of the membrane (e.g., by causing the membrane to become cloudy, swell, and/or to lose tension. In some examples, the coating may both appreciably reduce bubble formation, and appreciably reduce fluid diffusion into the membrane (e.g., by reducing the rate of fluid diffusion into the membrane by at least 50%, compared to an uncoated membrane under similar conditions).

In some examples, a fluid lens may include a substrate. The substrate may be relatively rigid, and may exhibit no visually perceptible deformation due to, for example, adjusting the internal pressure of the fluid and/or tension on the membrane. In some examples, the substrate may be a generally transparent planar sheet. The substrate may include one more substrate layers, and a substrate layer may include a polymer, glass, optical film, and the like. Example glasses include silicate glasses, such as borosilicate glasses. In some examples, a substrate may include one or more polymers, such as an acrylate polymer (e.g., polymethylmethacrylate), a polycarbonate, a polyurethane (such as an aromatic polyurethane), or other suitable polymer. In some examples, one or more surfaces of a substrate may be planar, spherical, cylindrical, spherocylindrical, convex, concave, parabolic, bifocal, progressive, digressive, or have a freeform surface curvature. One or more surfaces of a substrate may approximate a prescription of a user, and adjustment of the membrane profile may be used to provide an improved prescription, for example, for reading, distance viewing, or other use. In some embodiments the lens fluid may have a refractive index that is similar to that of the substrate material and an external surface of the substrate may have a shape of the kind described. One or both surfaces of a substrate may approximate a prescription of a user, and adjustment of the membrane profile (e.g., by adjustment of the membrane curvature) may be used to provide an improved prescription, for example, for reading, distance viewing, or other use. In some examples, the substrate may have no significant optical power, for example, by having parallel planar surfaces.

Membrane deformation may be used to adjust an optical parameter, such as a focal length, around a center value determined by relatively fixed surface curvature(s) of a substrate or other optical element, for example, of one or both surfaces of a substrate.

In some examples, the substrate may include an elastomer, and may in some examples have an adjustable profile (that may have a smaller range of adjustments than provided by the membrane), and in some examples the substrate may be omitted and the fluid enclosed by a pair of membranes or other flexible enclosure configuration.

In some examples, a fluid lens may include one or more actuators. The one or more actuators may be used to modify the elastic tension of a membrane, and may hence modify an optical parameter of a fluid lens including the membrane. The membrane may be connected to a substrate around the periphery of the membrane, for example, using a connection assembly.

The connection assembly may include one or more of an actuator, a post, a wire, or other connection hardware. In some examples, one or more actuators are used to adjust the curvature of the membrane, and hence the optical properties of the fluid lens.

In some examples, a device including a fluid lens may include a one or more fluid lenses supported by a frame, such as ophthalmic glasses, goggles, visors, and the like. Applications of the devices or methods described herein include fluid lenses, and devices which may include one or more fluid lenses, such as eyewear devices (e.g., glasses, augmented reality devices, virtual reality devices, and the like), binoculars, telescopes, cameras, endoscopes, or any imaging device.

In some examples, a membrane, substrate, edge seal, or other lens component may be subject to a surface treatment, which may be provided before or after fluid lens assembly. In some examples, a polymer may be applied to the membrane, such as a polymer coating, for example, a fluoropolymer coating. A fluoropolymer coating may include one or more fluoropolymers, such as polytetrafluoroethylene, or its analogs, blends, or derivatives.

Applications may also include optical instruments and optical devices, and other applications of fluid lenses. In addition, applications may include any lens applications, such as ophthalmic lenses, optics, and other fluid lens applications. Fluid lenses may be incorporated into a variety of different devices, such as eyewear devices (e.g., glasses), binoculars, telescopes, cameras, endoscopes, and/or imaging devices. The principles described herein may be applied in connection with any form of fluid lens. Fluid lenses may also be incorporated into eyewear, such as wearable optical devices like eyeglasses, an augmented reality or virtual reality headset, and/or other wearable optical device. Due to these principles described herein, these devices may exhibit reduced thickness, reduced weight, improved wide-angle/field-of-view optics (e.g., for a given weight), and/or improved aesthetics.

Fluid lenses described herein may be used to correct for VAC, which may refer to, for example, user discomfort while using an augmented reality or virtual reality device. VAC may be caused by the focal plane of virtual content (related to eye accommodation) not matching the virtual content's apparent distance based on stereoscopy (related to eye vergence). Examples described herein include devices including one or more fluid lenses that may allow correction of VAC, while allowing reduction of the mass of the one or more fluid lenses using a negative optical power associated with the waveguide display. In some examples, a device may be configured so that the negative optical power of the front lens assembly (e.g., including a front adjustable lens) and/or the waveguide display assembly corrects for (e.g., reduces or substantially eliminates) VAC between a real-world image and an augmented reality image.

In augmented reality devices in which an augmented reality image (which may also be termed a virtual image) is viewed in superposition with a real-world image, a pair of fluid lenses of the kind described herein may be used with an intermediate transparent display; an inner lens to adjust the focal plane of a virtual image projected by the display and an outer lens to compensate for the inner lens so that light passing from outside through both lenses undergoes substantially no net change in focus, apart from a possible fixed prescription to correct for a user's vision.

In some examples, similar approaches may be used to lens mass and/or complexity in other optical devices. Applications of the instant disclosure include fluid-filled lens, for example, where the fluid includes one or more of a liquid, suspension, gas, or other fluid.

The present disclosure may anticipate or include various methods, such as computer-implemented methods. Method steps may be performed by any suitable computer-executable code and/or computing system, and may be performed by the control system of a virtual and/or augmented reality system. Each of the steps of example methods may represent an algorithm whose structure may include and/or may be represented by multiple sub-steps.

In some examples, a system according to the present disclosure may include at least one physical processor and physical memory including computer-executable instructions that, when executed by the physical processor, cause the physical processor to adjust the optical properties of a fluid lens substantially as described herein.

In some examples, a non-transitory computer-readable medium according to the present disclosure may include one or more computer-executable instructions that, when executed by at least one processor of a computing device, cause the computing device to adjust the optical properties of a fluid lens substantially as described herein.

In some examples, a fluid lens (e.g., a liquid lens) includes a substrate, a flexible membrane, and a fluid located with an enclosure formed between the substrate and the membrane. Bubble formation within the lens fluid may reduce optical quality and aesthetics of the lens. In some applications, reduced pressure may be applied (e.g., to obtain a concave lens surface, for negative optical power) and this may induce bubble formation on the inside surfaces of the substrate and membrane.

In some examples, inside surfaces (e.g., surfaces adjacent the lens fluid) may be treated to reduce or substantially eliminate bubble formation within the fluid of a fluid lens. The number of nucleation sites for bubble formation may be reduced using a surface coating and/or other treatment. The surface coating may be formed on the interior surface of the enclosure before filling the enclosure with the fluid, and in some examples may occur after filing using components added to the fluid. For example, the surfaces may be coated with a polymer layer (e.g., by polymerizing a surface monomer layer), or with a fluid, gel, or emulsion layer that is immiscible with the lens liquid. A coating may include one or more of various materials, such as an acrylate polymer, a silicone polymer, an epoxy-based polymer, or a fluoropolymer. In some examples, a coating may include a fluoroacrylate polymer, such as perfluoroheptylacrylate, or other fluoroalkylated acrylate polymer.

Ophthalmic applications of the devices described herein include spectacles with a flat front (or other curved) substrate and an adjustable eye-side concave or convex membrane surface. Applications include optics, and other applications of fluid lenses, including augmented reality or virtual reality headsets.

### EXAMPLE EMBODIMENTS

Example 1: An example device may include an optical configuration, where the optical configuration includes: a front lens assembly including a front adjustable lens; a waveguide display assembly configured to provide augmented reality light; and a rear lens assembly including a rear adjustable lens, where the waveguide display assembly is located between the front lens assembly and the rear lens assembly, a combination of the waveguide display assembly and the rear lens assembly provide a negative optical power for the augmented reality light, and the device is configured to provide an augmented reality image formed using the augmented reality light within a real-world image.

Example 2. The device of example 1, where the real-world image is formed by real-world light received by the front lens assembly, the real-world light then passing through at least a portion of the waveguide display assembly and the rear lens assembly.

Example 3. The device of examples 1 or 2, where the device is configured so that, when worn by a user, the front lens assembly receives real-world light used to form the real-world image, and the rear lens assembly is located proximate an eye of the user.

Example 4. The device of any of examples 1-3, where the device is configured so that the negative optical power corrects for vergence-accommodation conflict (VAC) between the real-world image and the augmented reality image.

Example 5. The device of any of examples 1-4, where the waveguide display assembly provides at least a portion of the negative optical power for the augmented reality light.

Example 6. The device of any of examples 1-5, where the waveguide display assembly includes a waveguide display and a negative lens.

Example 7. The device of any of examples 1-6, where the waveguide display assembly has a negative optical power of between approximately −1.5 D and −2.5 D, where D represents diopters.

Example 8. The device of any of examples 1-7, where the waveguide display assembly includes a waveguide display and the waveguide display provides the at least a portion of the negative optical power.

Example 9. The device of any of examples 1-8, where the waveguide display assembly includes a grating.

Example 10. The device of any of examples 1-9, where the front adjustable lens includes a front adjustable fluid lens having a front substrate, a front membrane, and a front lens fluid located between the front substrate and the front membrane.

Example 11. The device of any of examples 1-10, where the rear adjustable lens includes a rear adjustable fluid lens having a rear substrate, a rear membrane, and a rear lens fluid located between the rear substrate and the rear membrane.

Example 12. The device of any of examples 1-11, where the rear lens assembly provides at least some of the negative optical power.

Example 13. The device of any of examples 1-12, where the front lens assembly has a positive optical power.

Example 14. The device of example 13, where the positive optical power and the negative optical power are approximately equal in magnitude.

Example 15. The device of any of examples 1-14, where the rear lens assembly includes the rear adjustable lens and a supplemental negative lens.

Example 16. The device of any of examples 1-15, where: the rear adjustable lens includes a substrate; and the substrate has a concave exterior surface.

Example 17. The device of any of examples 1-16, where: real-world light is received by the device through the front lens assembly and passes through the waveguide display assembly and the rear lens assembly to form the real-world image; the augmented reality light is provided by the waveguide display assembly and passes through the rear lens assembly to form the augmented reality image; and the negative optical power reduces vergence-accommodation conflict between the real-world image and the augmented reality image.

Example 18. The device of any of examples 1-17, where the device is an augmented reality headset.

Example 19. An example method may include: receiving real-world light through a front lens assembly and generating a real-world image by directing the real-world light through a waveguide display and a rear lens assembly; and directing augmented reality light from the waveguide display through the rear lens assembly to form an augmented reality image, where: the waveguide display and the rear lens assembly cooperatively provide a negative optical power for the augmented reality light, and the front lens assembly, waveguide display, and the rear lens assembly cooperatively provide an approximately zero optical power for the real-world light.

Example 20. The method of example 19, where the waveguide display receives the augmented reality light from an augmented reality light source and directs the augmented reality light out of the waveguide display using a grating.

FIG. 18 shows an example near-eye display system such as an augmented reality system. The system 1800 may include a near-eye display (NED) 1810 and a control system 1820, which may be communicatively coupled to each other. The near-eye display 1810 may include lenses 1812, electroactive devices 1814, displays 1816, and a sensor 1818. Control system 1820 may include a control element 1822, a force lookup table 1824, and augmented reality logic 1826. Augmented reality logic 1826 may determine what virtual objects are to be displayed and real-world positions onto which the virtual objects are to be projected.

Accordingly, augmented reality logic 1826 may generate an image stream 1828 that is displayed by displays 1816 in such a way that alignment of right- and left-side images displayed in displays 1816 results in ocular vergence toward a desired real-world position.

The control element 1822 may be configured to control one or more adjustable lenses, for example, a fluid element located within a near-eye display. Lens adjustment may be based on the desired perceived distance to a virtual object (such as an augmented reality image element).

Control element 1822 may use the same positioning information determined by augmented reality logic 1826, in combination with force lookup table (LUT) 1824, to determine an amount of force to be applied by electroactive devices 1814 (e.g., actuators), as described herein, to lenses 1821. Electroactive devices 1814 may, responsive to control element 1822, apply appropriate forces to lenses 1821 to adjust the apparent accommodation distance of virtual images displayed in displays 1816 to match the apparent vergence distance of the virtual images, thereby reducing or eliminating vergence-accommodation conflict. Control element 1822 may be in communication with sensor 1818, which may measure a state of the adjustable lens. Based on data received from sensor 1818, the control element 1822 may adjust electroactive devices 1814 (e.g., as a closed-loop control system).

In some embodiments, display system 1800 may display multiple virtual objects at once and may determine which virtual object a user is viewing (or is likely to be viewing) to identify a virtual object for which to correct the apparent accommodation distance. For example, the system may include an eye-tracking system (not shown) that provides information to control element 1822 to enable control element 1822 to select the position of the relevant virtual object.

Additionally or alternatively, augmented reality logic 1826 may provide information about which virtual object is the most important and/or most likely to draw the attention of the user (e.g., based on spatial or temporal proximity, movement, and/or a semantic importance metric attached to the virtual object). In some embodiments, the augmented reality logic 1826 may identify multiple potentially important virtual objects and select an apparent accommodation distance that approximates the virtual distance of a group of the potentially important virtual objects.

Control system 1820 may represent any suitable hardware, software, or combination thereof for managing adjustments to adjustable lenses 1821. In some embodiments, control system 1820 may represent a system on a chip (SOC). As such, one or more portions of control system 1820 may include one or more hardware modules. Additionally or alternatively, one or more portions of control system 1820 may include one or more software modules that perform one or more of the tasks described herein when stored in the memory of a computing device and executed by a hardware processor of the computing device.

Control system 1820 may generally represent any suitable system for providing display data, augmented reality data, and/or augmented reality logic for a head-mounted display. In some embodiments, a control system 1820 may include a graphics processing unit (GPU) and/or any other type of hardware accelerator designed to optimize graphics processing.

Control system 1820 may be implemented in various types of systems, such as augmented reality glasses, which may further include one or more adjustable focus lenses coupled to a frame (e.g., using an eyewire). In some embodiments, a control system may be integrated into a frame of an eyewear device. Alternatively, all or a portion of control system may be in a system remote from the eyewear, and, for example, configured to control electroactive devices (e.g., actuators) in the eyewear via wired or wireless communication. In some examples, a single display may be used to provide virtual image elements (such as augmented reality image elements) into one or both eyes of a user.

FIG. 19 illustrates a perspective view of a display device 1900, in accordance with some embodiments. The display device 1900 may be a component (e.g., the waveguide display assembly or part of the waveguide) of a NED. In some embodiments, the display device 1900 may part of some other NEDs, or another system that directs display image light to a particular location. Depending on embodiments and implementations, the display device 1900 may also be referred to as a waveguide display and/or a scanning display. However, in some embodiments, the display device 1900 may not include a scanning mirror. For example, the display device 1900 may include matrices of light emitters that project light on an image field through a waveguide display, but without a scanning mirror. In some embodiments, the image emitted by the two-dimensional matrix of light emitters may be magnified by an optical assembly (e.g., lens) before the light arrives a waveguide or a screen.

For some embodiments, for example, including an optical configuration including a waveguide display, the display device 1900 may include a source assembly 1910, an output waveguide 1920, and a controller 1930. The display device 1900 may provide images for both eyes or for a single eye. For purposes of illustration, FIG. 19 shows the display device 1900 associated with a single eye 1922. Another display device (not shown), separated (or partially separated) from the display device 1900, may provide image light to another eye of the user. In a partially separated system, one or more components may be shared between display devices for each eye.

In this example, the source assembly 1910 generates image light 1955. The source assembly 1910 may include a light source 1940 and an optics system 1945. The light source 1940 may include an optical component that generates image light using a plurality of light emitters arranged in a matrix. Each light emitter may emit monochromatic light. The light source 1940 generates image light including, but not restricted to, red image light, blue image light, green image light, infra-red image light, etc. While RGB (red-green-blue) is often discussed in this disclosure, embodiments described herein are not limited to using red, blue, and green as primary colors. Other colors are also possible to be used as the primary colors of the display device. Also, a display device in accordance with an embodiment may use more than three primary colors.

The optics system 1945 may perform a set of optical processes, including, but not restricted to, focusing, combining, conditioning, and scanning processes on the image light generated by the light source 1940.

In some embodiments, the optics system 1945 may include a combining assembly, a light conditioning assembly, and a scanning mirror assembly. The source assembly 1910 may generate and output image light 1955 to a coupling element 1950 of the output waveguide 1920. In this context, the output waveguide provides the waveguide display in various examples described elsewhere in this disclosure.

In this example, the output waveguide 1920 is an optical waveguide that outputs image light to an eye of a user, and may be used to provide an augmented display image element. The output waveguide 1920 may receive the image light 1955 at one or more coupling elements 1950 and guide the received input image light to one or more decoupling elements 1960. The coupling element 1950 may be, for example, a diffraction grating, a holographic grating, some other element that couples the image light 1955 into the output waveguide 1920, or some combination thereof. For example, in embodiments where the coupling element 1950 is diffraction grating, the pitch of the diffraction grating is chosen such that total internal reflection occurs, and the image light 1955 propagates internally toward the decoupling element 1960. The pitch of the diffraction grating may be in the range of 300 nm to 600 nm.

The decoupling element 1960 may decouple the total internally reflected image light from the output waveguide 1920. The decoupling element 1960 may be, for example, a diffraction grating, a holographic grating, some other element that decouples image light out of the output waveguide 1920, or some combination thereof. For example, in embodiments where the decoupling element 1960 is a diffraction grating, the pitch of the diffraction grating may be chosen to cause incident image light to exit the output waveguide 1920. An orientation and position of the image light exiting from the output waveguide 1920 may be controlled by changing an orientation and position of the image light 1955 entering the coupling element 1950. In some examples, the pitch of the diffraction grating may be in the range of 300 nm to 600 nm.

The output waveguide 1920 may include one or more materials that facilitate total internal reflection of the image light 1955. The output waveguide 1920 may include, for example, silicon, plastic, glass, or polymers, or some combination thereof. The output waveguide 1920 may have a relatively small form factor. For example, the output waveguide 1920 may be approximately 50 mm wide along the X-dimension, 30 mm long along the Y-dimension, and 0.5-1 mm thick along the Z-dimension.

The controller 1930 may control the image rendering operations of the source assembly 1910. The controller 1930 may determine instructions for the source assembly 1910 based at least on the one or more display instructions. Display instructions may include instructions to render one or more images. In some embodiments, display instructions may include an image file (e.g., bitmap data). The display instructions may be received from, for example, a console of a VR system (not shown here). Scanning instructions may represent instructions used by the source assembly 1910 to generate image light 1955. The scanning instructions may include, for example, a type of a source of image light (e.g., monochromatic, polychromatic), a scanning rate, an orientation of a scanning apparatus, one or more illumination parameters, or some combination thereof. The controller 1930 may include a combination of hardware, software, and/or firmware not shown here so as not to obscure other aspects of the disclosure.

In some embodiments, an electronic display may include a light emitter, which may include one or more light emitting diodes, such as microLEDs. In some embodiments, a microLED may have a size (e.g., a diameter of the emission surface of the microLED) of between approximately 10 nm and approximately 20 microns. In some embodiments, an arrangement of microLEDs may have a pitch (e.g., a spacing between two microLEDs) of between approximately 10 nm and approximately 20 microns. The pitch may be a spacing between adjacent microLEDs. In some examples, the pitch may be a center to center spacing of microLEDs, and may be within a range having a lower bound based on the diameter of the emission surface. In some embodiments, other types of light emitters may be used. In some embodiments, an optical combiner may include the waveguide and one or more additional optical components as described herein.

In some embodiments, a waveguide display assembly may be configured to direct the image light (e.g., augmented reality image light projected from an electronic display) to the eye of a user through what may be termed the exit pupil. The waveguide display assembly may include one or more materials (e.g., plastic, glass, and the like), and various optical components may have one or more refractive indices, or, in some embodiments, a gradient refractive index. The waveguide display assembly may be configured to effectively reduce the weight and widen a field of view (FOV) of a NED. In some embodiments, a NED may include one or more optical elements between the waveguide display assembly and the eye. For example, the optical elements may be configured to magnify image light emitted from the waveguide display assembly, and/or to provide other optical adjustment(s) of image light emitted from the waveguide display assembly. For example, the optical element configuration may include one or more of an aperture, a Fresnel lens, a convex lens, a concave lens, a filter, or any other suitable optical element, for example, configured to correct aberrations in image light emitted from the waveguide display assembly. In some embodiments, a waveguide display assembly may produce and direct pupil replications to the eyebox region. An exit pupil may include a location where the eye is positioned in an eyebox region when the user wears the device, such as a device including a NED. In some embodiments, the device may include a frame configured to support the device on the body, such as the head, or a user, a frame of eye-wear glasses (also referred to herein as simply glasses). In some embodiments, a second optical combiner including, for example, a waveguide display assembly, may be used to provide image light to another eye of the user.

In some embodiments, an electronic display (which may also be termed a display device) may include one or more, such as a plurality, of monochromatic light emitter arrays, such as projector arrays. One or more of the arrays may include a reduced number of light emitters compared to other arrays so that a color channel associated with an array with the reduced number has a reduced resolution compared to other color channels. The light emitted by light emitters of different arrays may be converged by an optical component such as a waveguide so that the light of different colors spatially overlap at each image pixel location. The display device may include an image processing unit that applies an anti-aliasing filter that may include a plurality of convolution kernels to reduce any visual effects perceived by users with respect to one or more color channels having a reduced resolution. In some embodiments, the device may be configured to be worn by a user, and the device may be configured so that the augmented reality image element is projected towards an eye of the user after passing through the optical combiner. In some embodiments, the augmented reality image element includes a plurality of color channels, the electronic display includes a separate projector array for each color channel, and each projector array may be coupled into the optical combiner, which may include one or more waveguides. In some examples, the electronic display includes a plurality of projector arrays, with each projector array of the plurality of projector arrays providing a color channel, and each color channel may be coupled into the optical combiner. Each projector array may include a microLED array, for example, a microLED array having microLEDs spaced apart by less than approximately 5 microns, for example, less than approximately 2 microns. MicroLEDs in an arrangement (such as an array) may have a size (e.g., a diameter of the emission surface of the LED device) and/or a pitch (e.g., a spacing between the edges or centers of two proximate microLEDs) of between approximately 10 nm and approximately 20 microns. The lower bound of a center-to-center pitch range may be determined, at least in part, by the diameter of the emission surface. In some examples, microLED arrangements, such as arrays, may have a spacing between microLEDs (e.g., edge-to-edge distance) of between approximately 10 nm and approximately 20 microns.

In some embodiments, a source assembly may include a light source configured to emit light that may be processed optically by an optics system to generate image light that may be projected onto an image field. The light source may be driven by a driver circuit, based on the data sent from a controller or an image processing unit. In some embodiments, the driver circuit may include a circuit panel that may connect to and may mechanically hold one or more light emitters of the light source. The combination of a driver circuit and the light source may sometimes be referred to as a display panel or an LED panel (e.g., the latter if the light emitters include some form of LED).

The light source may generate a spatially coherent or a partially spatially coherent image light. The light source may include multiple light emitters. The light emitters can be vertical enclosure surface emitting laser (VCSEL) devices, light emitting diodes (LEDs), microLEDs, tunable lasers, and/or some other light emitting devices. In one embodiment, the light source includes a matrix of light emitters. In some embodiments, the light source includes multiple sets of light emitters with each set grouped by color and arranged in a matrix form. The light source emits light in a visible band (e.g., from about 390 nm to 700 nm). The light source emits light in accordance with one or more illumination parameters that are set by the controller and potentially adjusted by image processing unit and driver circuit. An illumination parameter may be an instruction used by the light source to generate light. An illumination parameter may include, for example, source wavelength, pulse rate, pulse amplitude, beam type (continuous or pulsed), other parameter(s) that affect the emitted light, or some combination thereof. The light source may emit source light. In some embodiments, the source light may include multiple beams of red light, green light, and blue light, or some combination thereof.

The optics system may include one or more optical components that optically adjust and potentially re-direct the light from the light source. One form of example adjustment of light may include conditioning the light. Conditioning the light from the light source may include, for example, expanding, collimating, correcting for one or more optical errors (e.g., field curvature, chromatic aberration, etc.), some other adjustment of the light, or some combination thereof. The optical components of the optics system may include, for example, lenses, mirrors, apertures, gratings, or some combination thereof. Light emitted from the optics system may be referred to as an image light.

The optics system may redirect image light via its one or more reflective and/or refractive portions so that the image light is projected at a particular orientation toward the output waveguide. Where the image light is redirected toward may be based on specific orientations of the one or more reflective and/or refractive portions. In some embodiments, the optics system includes a single scanning mirror that scans in at least two dimensions. In some embodiments, the optics system may include a plurality of scanning mirrors that each scan in orthogonal directions to each other. The optics system may perform a raster scan (horizontally, or vertically), a biresonant scan, or some combination thereof. In some embodiments, the optics system may perform a controlled vibration along the horizontal and/or vertical directions with a specific frequency of oscillation to scan along two dimensions and generate a two-dimensional projected line image of the media presented to user's eyes. In some embodiments, the optics system may also include a lens that serves similar or same function as one or more scanning mirror.

In some embodiments, the optics system may include a galvanometer mirror. For example, the galvanometer mirror may represent any electromechanical instrument that indicates that it has sensed an electric current by deflecting a beam of image light with one or more mirrors. The galvanometer mirror may scan in at least one orthogonal dimension to generate the image light. The image light from a galvanometer mirror may represent a two-dimensional line image of the media presented to the user's eyes.

In some embodiments, the source assembly may not include an optics system. In some embodiments, light emitted by the light source may be projected directly into the waveguide. In some examples, the output optics of the light source may include a negative lens.

The controller may control the operations of the light source and, in some cases, the optics system. In some embodiments, the controller may be the graphics processing unit (GPU) of a display device. In some embodiments, the controller may include one or more different or additional processors. The operations performed by the controller may include taking content for display and dividing the content into discrete sections. The controller may instruct the light source to sequentially present the discrete sections using light emitters corresponding to a respective row in an image ultimately displayed to the user. The controller may instruct the optics system to adjust the light. For example, the controller may control the optics system to scan the presented discrete sections to different areas of a coupling element of the output waveguide. Accordingly, at the exit pupil of the output waveguide, each discrete portion may be presented in a different location. While each discrete section is presented at different times, the presentation and scanning of the discrete sections may occur fast enough such that a user's eye integrates the different sections into a single image or series of images. The controller may also provide scanning instructions to the light source that include an address corresponding to an individual source element of the light source and/or an electrical bias applied to the individual source element.

An image processing unit may be a general-purpose processor and/or one or more application-specific circuits that are dedicated to performing the features described herein. In one embodiment, a general-purpose processor may be coupled to a memory device to execute software instructions that cause the processor to perform certain processes described herein. In some embodiments, the image processing unit may include one or more circuits that are dedicated to performing certain features. The image processing unit may be a stand-alone unit that is separate from the controller and the driver circuit, but in some embodiments the image processing unit may be a sub-unit of the controller or the driver circuit. In other words, in those embodiments, the controller or the driver circuit performs various image processing procedures of the image processing unit. The image processing unit may also be referred to as an image processing circuit.

FIG. 20 is a diagram illustrating a waveguide configuration to form an image and replications of images that may be referred to as pupil replications, in accordance with some embodiments. The light source of the display device may be separated into three different light emitter arrays. The primary colors may be red, green, and blue, or another combination of other suitable primary colors such as red, yellow, and blue. In some embodiments, the number of light emitters in each light emitter array may be equal to the number of pixel locations an image field. Instead of using a scanning process, each light emitter may be dedicated to generating images at a respective pixel location in the image field. In some embodiments, configurations discussed herein may be combined.

The embodiments depicted in FIG. 20 may provide for the projection of many image replications (e.g., pupil replications) or decoupling a single image projection at a single point. Accordingly, additional embodiments of disclosed NEDs may provide for a single decoupling element. Outputting a single image toward the eyebox may preserve the intensity of the coupled image light. Some embodiments that provide for decoupling at a single point may further provide for steering of the output image light. Such pupil-steering NEDs may further include systems for eye tracking to monitor a user's gaze. Some embodiments of the waveguide configurations that provide for pupil replication, as described herein, may provide for one-dimensional replication, while some embodiments may provide for two-dimensional replication. For simplicity, one-dimensional pupil replication is shown in FIG. 20. Two-dimensional pupil replication may include directing light into and outside the plane of FIG. 20. FIG. 20 is presented in a simplified format. The detected gaze of the user may be used to adjust the position and/or orientation of the light emitter arrays individually or the light source 2070 as a whole and/or to adjust the position and/or orientation of the waveguide configuration.

In FIG. 20, a waveguide configuration 2040 may be disposed in cooperation with a light source 2070, which may include one or more monochromatic light emitter arrays 2080 secured to a support 2064 (e.g., a printed circuit board or another structure). The support 2064 may be coupled to a frame (such as, e.g., a frame of augmented reality glasses or goggles) or other structure. The waveguide configuration 2040 may be separated from the light source 2070 by an air gap having a distance D1. The distance D1 may be in a range from approximately 50 μm to approximately 500 μm in some embodiments. The monochromatic image or images projected from the light source 2070 may pass through the air gap toward the waveguide configuration 2040. Any of the light source embodiments described herein may be utilized as the light source 2070.

The waveguide configuration may include a waveguide 2042, which may be formed from a glass or plastic material. The waveguide 2042 may include a coupling area 2044 and a decoupling area formed by decoupling elements 2046A on a top surface 2048A and decoupling elements 2046B on a bottom surface 2048B in some embodiments. The area within the waveguide 2042 in between the decoupling elements 2046A and 2046B may be considered a propagation area 2050, in which light images received from the light source 2070 and coupled into the waveguide 2042 by coupling elements included in the coupling area 2044 may propagate laterally within the waveguide 2042.

The coupling area 2044 may include a coupling element 2052 configured and dimensioned to couple light of a predetermined wavelength, for example, red, green, or blue light. When a white light emitter array is included in the light source 2070, the portion of the white light that falls in the predetermined wavelength may be coupled by each of the coupling elements 2052. In some embodiments, the coupling elements 2052 may be gratings, such as Bragg gratings, dimensioned to couple a predetermined wavelength of light. In some embodiments, the gratings of each coupling element 2052 may exhibit a separation distance between gratings associated with the predetermined wavelength of light that the particular coupling element 2052 is to couple into the waveguide 2042, resulting in different grating separation distances for each coupling element 2052. Accordingly, each coupling element 2052 may couple a limited portion of the white light from the white light emitter array when included. In other examples, the grating separation distance may be the same for each coupling element 2052. In some embodiments, coupling element 2052 may be or include a multiplexed coupler.

As shown in FIG. 20, a red image 2060A, a blue image 2060B, and a green image 2060C may be coupled by the coupling elements of the coupling area 2044 into the propagation area 2050 and may begin traversing laterally within the waveguide 2042. In one embodiment, the red image 2060A, the blue image 2060B, and the green image 2060C, each represented by a different dash line in FIG. 20, may converge to form an overall image that is represented by a solid line. For simplicity, FIG. 20 may show an image by a single arrow, but each arrow may represent an image field where the image is formed. In some embodiments, red image 2060A, the blue image 2060B, and the green image 2060C, may correspond to different spatial locations.

A portion of the light may be projected out of the waveguide 2042 after the light contacts the decoupling element 2046A for one-dimensional pupil replication, and after the light contacts both the decoupling element 2046A and the decoupling element 2046B for two-dimensional pupil replication. In two-dimensional pupil replication embodiments, the light may be projected out of the waveguide 2042 at locations where the pattern of the decoupling element 2046A intersects the pattern of the decoupling element 2046B.

The portion of light that is not projected out of the waveguide 2042 by the decoupling element 2046A may be reflected off the decoupling element 2046B. The decoupling element 2046B may reflect all incident light back toward the decoupling element 2046A, as depicted. Accordingly, the waveguide 2042 may combine the red image 2060A, the blue image 20606, and the green image 2060C into a polychromatic image instance, which may be referred to as a pupil replication 2062, which may be a polychromatic pupil replication. The pupil replication 2062 may be projected toward an eyebox of associated with a user's eye, which may interpret the pupil replication 2062 as a full-color image (e.g., an image including colors in addition to red, green, and blue). The waveguide 2042 may produce tens or hundreds of pupil replications, or may produce a single pupil replication.

In some embodiments, the waveguide configuration may differ from the configuration shown in FIG. 20. For example, the coupling area may be different. Rather than including gratings as coupling element 2052, an alternate embodiment may include a prism that reflects and refracts received image light, directing it toward the decoupling element 2046A.

FIG. 20 generally shows light source 2070 including light emitters arrays 2080 coupled to the support 2064. In some examples, light source 2070 may include separate monochromatic emitters arrays located at disparate locations about the waveguide configuration (e.g., one or more emitters arrays located near a top surface of the waveguide configuration and one or more emitters arrays located near a bottom surface of the waveguide configuration).

Also, although only three light emitter arrays are shown in FIG. 20, an embodiment may include more or fewer light emitter arrays. For example, in one embodiment, a display device may include two red arrays, two green arrays, and two blue arrays. In one case, the extra set of emitter panels provides redundant light emitters for the same pixel location. In another case, one set of red, green, and blue panels is responsible for generating light corresponding to the most significant bits of a color dataset for a pixel location while another set of panels is responsible for generating light corresponding the least significant bits of the color dataset.

In some embodiments, a display device may use both a rotating mirror and/or a waveguide to form an image, and, in some examples, to form multiple pupil replications.

In some embodiments, each source projector (R, G, B) may have an associated respective waveguide, for example, as part of a larger waveguide stack that combines a plurality of color channels, for example, red, green, blue, and/or other color channels. In some embodiments, a first waveguide might handle two color channels, while a second waveguide may handle a third color channel. Other permutations are possible, for example, in which one waveguide may handle two color channels, and a second waveguide may handle a third. In some embodiments, there may be two, three, four, or five color channels, or a combination of one or more color channels and a luminance channel, or other channel, and these channels may be divided amongst a plurality of waveguides in any desired permutation. In some examples, an optical combiner includes a separate waveguide for each of a plurality of color channels.

In some embodiments, an electronic display may include a plurality of first light emitters each configured to emit light of a first color, a plurality of second light emitters configured to emit light of a second color, and optionally a plurality of third light emitters each configured to emit light of a third color. In some embodiments, an optical combiner may include one or more waveguides configured to converge or otherwise direct the light emitted from the various light emitters to form an augmented reality image, for example, by overlapping the light from the various light emitters within a spatial location. In some embodiments, the light emitters may each emit an approximately monochromatic color light, which may correspond to a primary color such as red, green, or blue. In some embodiments, a light emitter may be configured to emit a band or combination of wavelength colors, as desirable in any specific application. In some embodiments, a light emitter may be configured to emit a UV (or blue or violet light) towards a photochromic layer, for example, to induce local or global dimming within the photochromic layer. The degree of local and/or global dimming may be controlled, for example, based on average and/or peak values of ambient light brightness.

In some embodiments, a display system (e.g., an NED) may include a pair of waveguide configurations. Each waveguide may be configured to project an image to an eye of a user. In some embodiments, a single waveguide configuration that is sufficiently wide to project images to both eyes may be used. The waveguide configurations may each include a decoupling area. In order to provide images to an eye of the user through the waveguide configuration, multiple coupling areas may be provided in a top surface of the waveguide of the waveguide configuration. The coupling areas may include multiple coupling elements to interface with light images provided by a first and second light emitter array sets, respectively. Each of the light emitter array sets may include a plurality of monochromatic light emitter arrays, for example, as described herein. In some embodiments, the light emitter array sets may each include a red light emitter array, a green light emitter array, and a blue light emitter array. Some light emitter array sets may further include a white light emitter array or a light emitter array emitting some other color or combination of colors.

In some embodiments, a right eye waveguide may include one or more coupling areas (all or a portion of which may be referred to collectively as coupling areas) and a corresponding number of light emitter array sets (all or a portion of which may be referred to collectively as the light emitter array sets). Accordingly, while the right eye waveguide may include two coupling areas and two light emitter array sets, some embodiments may include more or fewer (of each, or of both). In some embodiments, the individual light emitter arrays of a light emitter array set may be disposed at different locations around a decoupling area. For example, the light emitter array set may include a red light emitter array disposed along a left side of the decoupling area, a green light emitter array disposed along the top side of the decoupling area, and a blue light emitter array disposed along the right side of the decoupling area. Accordingly, light emitter arrays of a light emitter array set may be disposed all together, in pairs, or individually, relative to a decoupling area.

The left eye waveguide may include the same number and configuration of coupling areas and light emitter array sets as the right eye waveguide, in some embodiments. In some embodiments, the left eye waveguide and the right eye waveguide may include different numbers and configurations (e.g., positions and orientations) of coupling areas and light emitter array sets. In some embodiments, the pupil replication areas formed from different color light emitters may occupy different areas. For example, a red light emitter array of the light emitter array set may produce pupil replications of a red image within a limited area, and correspondingly for green and blue light. The limited areas may be different from one monochromatic light emitter array to another, so that only the overlapping portions of the limited areas may be able to provide full-color pupil replication, projected toward the eyebox. In some embodiments, the pupil replication areas formed from different color light emitters may occupy the same area.

In some embodiments, different waveguide portions may be connected by a bridge waveguide. The bridge waveguide may permit light from a light emitter array set to propagate from one waveguide portion into another waveguide portion. In some embodiments, the bridge waveguide portion may not include any decoupling elements, such that all light totally internally reflects within the waveguide portion. In some embodiments, the bridge waveguide portion may include a decoupling area. In some embodiments, the bridge waveguide may be used to obtain light from a plurality of waveguide portions and couple the obtained light to a detector (e.g., a photodetector), for example, to detect image misalignment between the waveguide portions.

In some embodiments, a combiner waveguide may be a single layer that has input gratings for different image color components, such as red, green, and blue light. In some embodiments, a combiner waveguide may include a stack of layers, where each layer may include input gratings for one or multiple color channels (e.g., a first layer for green, and a second layer for blue and red, or other configuration). In some examples, a dimmer element and an optical combiner, which may include one or more waveguides, may be integrated into a single component. In some examples, the dimmer element may be a separate component. In some examples, the device may be configured so that the dimmer element is located between the optical combiner and the eye(s) of a user when the device is worn by a user.

The output grating(s) may be configured to out-couple light in any desired direction that's opposite to our plan-of-record. For example, referring to FIG. 20, the output gratings may be configured to output light in the opposite direction from that shown in the figure (e.g., towards the same side of the microLED projectors). In some embodiments, the dimmer element may include a layer on either or both sides of the waveguide.

In some embodiments, the outside light may pass through a lens, such as an ophthalmic lens, before passing through the waveguide display. For example, a device may include ophthalmic lenses (such as one or more prescription lenses and/or adjustable lenses), and these may be located such that outside light passes through one or more ophthalmic lenses before passing through the waveguide. In some embodiments, a device may be configured to provide image correction for the augmented reality image element, for example, using one or more lenses, or one or more curved waveguide surfaces. In some embodiments, outside light may pass through the waveguide, and then the outside light and projected augmented reality light may both pass through one or more lenses (such as an ophthalmic lens and/or an adjustable lens). In some embodiments, a device may include an exterior optical element (e.g., a lens or window) through which outside light initially passes, which may include scratch-resistant glass or a scratch-resistant surface coating. In some embodiments, the pupil replications may be outcoupled in another direction (e.g., towards where the light emitters are located). In some examples, first and second waveguide displays may be used to project virtual image elements into first and second eyes of a user, respectively (e.g., left and right eyes). In some examples, a single waveguide display may be used to project virtual image elements into both eyes (e.g., a portion of the waveguide display may be used to project into one eye, and another portion of the waveguide display may be used to project into the other eye).

Embodiments of the present disclosure may include or be implemented in conjunction with various types of artificial reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely generated content or generated content combined with captured (e.g., real-world) content. The artificial-reality content may include video, audio, haptic feedback, or some combination thereof, any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

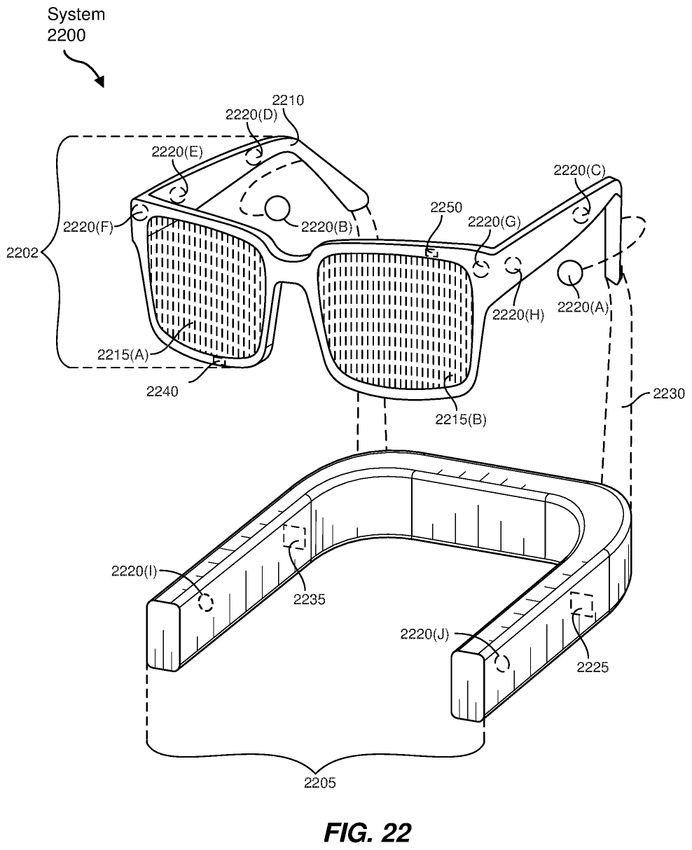

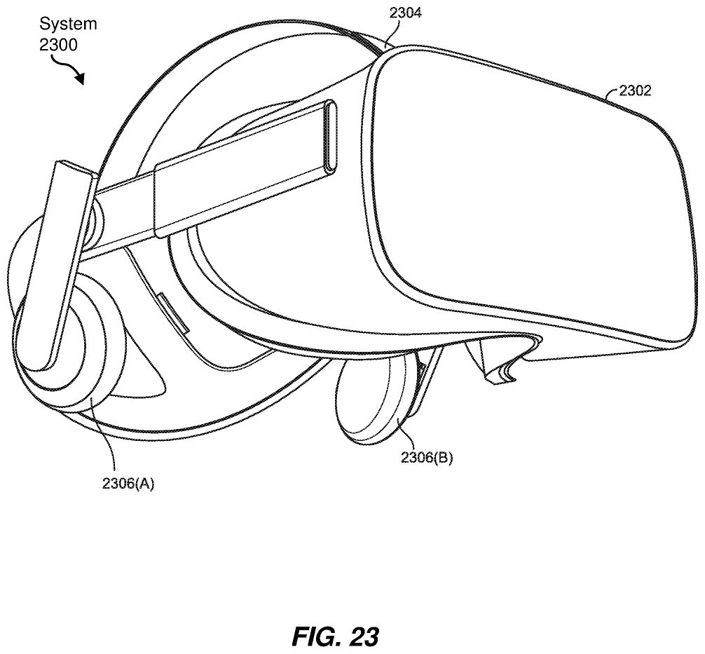

Artificial-reality systems may be implemented in a variety of different form factors and configurations. Some artificial reality systems may be designed to work without near-eye displays (NEDs), an example of which is augmented-reality system 2100 shown in FIG. 21. Other artificial reality systems may include a NED that also provides visibility into the real world (e.g., augmented-reality system 2200 in FIG. 22) or that visually immerses a user in an artificial reality (e.g., virtual-reality system 2300 in FIG. 23). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 21, augmented-reality system 2100 generally represents a wearable device dimensioned to fit about a body part (e.g., a head) of a user. As shown in FIG. 21, system 2100 may include a frame 2102 and a camera assembly 2104 that is coupled to frame 2102 and configured to gather information about a local environment by observing the local environment. Augmented-reality system 2100 may also include one or more audio devices, such as output audio transducers 2108(A) and 2108(B) and input audio transducers 2110. Output audio transducers 2108(A) and 2108(B) may provide audio feedback and/or content to a user, and input audio transducers 2110 may capture audio in a user's environment.

As shown, augmented-reality system 2100 may not necessarily include a NED positioned in front of a user's eyes. Augmented-reality systems without NEDs may take a variety of forms, such as head bands, hats, hair bands, belts, watches, wrist bands, ankle bands, rings, neckbands, necklaces, chest bands, eyewear frames, and/or any other suitable type or form of apparatus. While augmented-reality system 2100 may not include a NED, augmented-reality system 2100 may include other types of screens or visual feedback devices (e.g., a display screen integrated into a side of frame 2102).

Example embodiments discussed in this disclosure may be implemented in augmented-reality systems that include one or more NEDs. For example, as shown in FIG. 22, augmented-reality system 2200 may include an eyewear device 2202 with a frame 2210 configured to hold a left display device 2215(A) and a right display device 2215(B) in front of a user's eyes. Display devices 2215(A) and 2215(B) may act together or independently to present an image or series of images to a user. While augmented-reality system 2200 includes two displays, embodiments of this disclosure may be implemented in augmented-reality systems with a single NED or more than two NEDs.

In some embodiments, augmented-reality system 2200 may include one or more sensors, such as sensor 2240. Sensor 2240 may generate measurement signals in response to motion of augmented-reality system 2200 and may be located on substantially any portion of frame 2210. Sensor 2240 may represent a position sensor, an inertial measurement unit (IMU), a depth camera assembly, or any combination thereof. In some embodiments, augmented-reality system 2200 may or may not include sensor 2240 or may include more than one sensor. In embodiments in which sensor 2240 includes an IMU, the IMU may generate calibration data based on measurement signals from sensor 2240. Examples of sensor 2240 may include, without limitation, accelerometers, gyroscopes, magnetometers, other suitable types of sensors that detect motion, sensors used for error correction of the IMU, or some combination thereof. Augmented-reality system 2200 may also include a microphone array with a plurality of acoustic transducers 2220(A)-2220(J), referred to collectively as acoustic transducers 2220. Acoustic transducers 2220 may be transducers that detect air pressure variations induced by sound waves. Each acoustic transducer 2220 may be configured to detect sound and convert the detected sound into an electronic format (e.g., an analog or digital format). The microphone array in FIG. 2 may include, for example, ten acoustic transducers: 2220(A) and 2220(B), which may be designed to be placed inside a corresponding ear of the user, acoustic transducers 2220(C), 2220(D), 2220(E), 2220(F), 2220(G), and 2220(H), which may be positioned at various locations on frame 2210, and/or acoustic transducers 2220(I) and 2220(J), which may be positioned on a corresponding neckband 2205.

In some embodiments, one or more of acoustic transducers 2220(A)-(F) may be used as output transducers (e.g., speakers). For example, acoustic transducers 2220(A) and/or 2220(B) may be earbuds or any other suitable type of headphone or speaker.

The configuration of acoustic transducers 2220 of the microphone array may vary. While augmented-reality system 2200 is shown in FIG. 22 as having ten acoustic transducers 2220, the number of acoustic transducers 2220 may be greater or less than ten. In some embodiments, using higher numbers of acoustic transducers 2220 may increase the amount of audio information collected and/or the sensitivity and accuracy of the audio information. In contrast, using a lower number of acoustic transducers 2220 may decrease the computing power required by the controller 2250 to process the collected audio information. In addition, the position of each acoustic transducer 2220 of the microphone array may vary. For example, the position of an acoustic transducer 2220 may include a defined position on the user, a defined coordinate on frame 2210, an orientation associated with each acoustic transducer, or some combination thereof.

Acoustic transducers 2220(A) and 2220(B) may be positioned on different parts of the user's ear, such as behind the pinna or within the auricle or fossa. Or, there may be additional acoustic transducers on or surrounding the ear in addition to acoustic transducers 2220 inside the ear canal. Having an acoustic transducer positioned next to an ear canal of a user may enable the microphone array to collect information on how sounds arrive at the ear canal. By positioning at least two of acoustic transducers 2220 on either side of a user's head (e.g., as binaural microphones), augmented-reality system 2200 may simulate binaural hearing and capture a 3D stereo sound field around about a user's head. In some embodiments, acoustic transducers 2220(A) and 2220(B) may be connected to augmented-reality system 2200 via a wired connection 2230, and in other embodiments, acoustic transducers 2220(A) and 2220(B) may be connected to augmented-reality system 2200 via a wireless connection (e.g., a Bluetooth connection). In still other embodiments, acoustic transducers 2220(A) and 2220(B) may not be used at all in conjunction with augmented-reality system 2200.

Acoustic transducers 2220 on frame 2210 may be positioned along the length of the temples, across the bridge, above or below display devices 2215(A) and 2215(B), or some combination thereof. Acoustic transducers 2220 may be oriented such that the microphone array is able to detect sounds in a wide range of directions surrounding the user wearing the augmented-reality system 2200. In some embodiments, an optimization process may be performed during manufacturing of augmented-reality system 2200 to determine relative positioning of each acoustic transducer 2220 in the microphone array.

In some examples, augmented-reality system 2200 may include or be connected to an external device (e.g., a paired device), such as neckband 2205. Neckband 2205 generally represents any type or form of paired device. Thus, the following discussion of neckband 2205 may also apply to various other paired devices, such as charging cases, smart watches, smart phones, wrist bands, other wearable devices, hand-held controllers, tablet computers, laptop computers and other external compute devices, etc.

As shown, neckband 2205 may be coupled to eyewear device 2202 via one or more connectors. The connectors may be wired or wireless and may include electrical and/or non-electrical (e.g., structural) components. In some cases, eyewear device 2202 and neckband 2205 may operate independently without any wired or wireless connection between them. While FIG. 22 illustrates the components of eyewear device 2202 and neckband 2205 in example locations on eyewear device 2202 and neckband 2205, the components may be located elsewhere and/or distributed differently on eyewear device 2202 and/or neckband 2205. In some embodiments, the components of eyewear device 2202 and neckband 2205 may be located on one or more additional peripheral devices paired with eyewear device 2202, neckband 2205, or some combination thereof. Furthermore,

Pairing external devices, such as neckband 2205, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 2200 may be provided by a paired device or shared between a paired device and an eyewear device, thus reducing the weight, heat profile, and form factor of the eyewear device overall while still retaining desired functionality. For example, neckband 2205 may allow components that would otherwise be included on an eyewear device to be included in neckband 2205 since users may tolerate a heavier weight load on their shoulders than they would tolerate on their heads. Neckband 2205 may also have a larger surface area over which to diffuse and disperse heat to the ambient environment. Thus, neckband 2205 may allow for greater battery and computation capacity than might otherwise have been possible on a stand-alone eyewear device. Since weight carried in neckband 2205 may be less invasive to a user than weight carried in eyewear device 2202, a user may tolerate wearing a lighter eyewear device and carrying or wearing the paired device for greater lengths of time than a user would tolerate wearing a heavy standalone eyewear device, thereby enabling users to more fully incorporate artificial reality environments into their day-to-day activities.

Neckband 2205 may be communicatively coupled with eyewear device 2202 and/or to other devices. These other devices may provide certain functions (e.g., tracking, localizing, depth mapping, processing, storage, etc.) to augmented-reality system 2200. In the embodiment of FIG. 22, neckband 2205 may include two acoustic transducers (e.g., 2220(I) and 2220(J)) that are part of the microphone array (or potentially form their own microphone subarray). Neckband 2205 may also include a controller 2225 and a power source 2235.

Acoustic transducers 2220(I) and 2220(J) of neckband 2205 may be configured to detect sound and convert the detected sound into an electronic format (analog or digital). In the embodiment of FIG. 22, acoustic transducers 2220(I) and 2220(J) may be positioned on neckband 2205, thereby increasing the distance between the neckband acoustic transducers 2220(I) and 2220(J) and other acoustic transducers 2220 positioned on eyewear device 2202. In some cases, increasing the distance between acoustic transducers 2220 of the microphone array may improve the accuracy of beamforming performed via the microphone array. For example, if a sound is detected by acoustic transducers 2220(C) and 2220(D) and the distance between acoustic transducers 2220(C) and 2220(D) is greater than, for example, the distance between acoustic transducers 2220(D) and 2220(E), the determined source location of the detected sound may be more accurate than if the sound had been detected by acoustic transducers 2220(D) and 2220(E).

Controller 2225 of neckband 2205 may process information generated by the sensors on 2205 and/or augmented-reality system 2200. For example, controller 2225 may process information from the microphone array that describes sounds detected by the microphone array. For each detected sound, controller 2225 may perform a direction-of-arrival (DOA) estimation to estimate a direction from which the detected sound arrived at the microphone array. As the microphone array detects sounds, controller 2225 may populate an audio data set with the information. In embodiments in which augmented-reality system 2200 includes an inertial measurement unit, controller 2225 may compute all inertial and spatial calculations from the IMU located on eyewear device 2202. A connector may convey information between augmented-reality system 2200 and neckband 2205 and between augmented-reality system 2200 and controller 2225. The information may be in the form of optical data, electrical data, wireless data, or any other transmittable data form. Moving the processing of information generated by augmented-reality system 2200 to neckband 2205 may reduce weight and heat in eyewear device 2202, making it more comfortable to the user.

Power source 2235 in neckband 2205 may provide power to eyewear device 2202 and/or to neckband 2205. Power source 2235 may include, without limitation, lithium ion batteries, lithium-polymer batteries, primary lithium batteries, alkaline batteries, or any other form of power storage. In some cases, power source 2235 may be a wired power source. Including power source 2235 on neckband 2205 instead of on eyewear device 2202 may help better distribute the weight and heat generated by power source 2235.

As noted, some artificial reality systems may, instead of blending an artificial reality with actual reality, substantially replace one or more of a user's sensory perceptions of the real world with a virtual experience. One example of this type of system is a head-worn display system, such as virtual-reality system 2300 in FIG. 23, that mostly or completely covers a user's field of view. Virtual-reality system 2300 may include a front rigid body 2302 and a band 2304 shaped to fit around a user's head. Virtual-reality system 2300 may also include output audio transducers 2306(A) and 2306(B). Furthermore, while not shown in FIG. 23, front rigid body 2302 may include one or more electronic elements, including one or more electronic displays, one or more inertial measurement units (IMUS), one or more tracking emitters or detectors, and/or any other suitable device or system for creating an artificial reality experience.

Artificial reality systems may include a variety of types of visual feedback mechanisms. For example, display devices in augmented-reality system 2300 and/or virtual-reality system 2300 may include one or more liquid crystal displays (LCDs), light emitting diode (LED) displays, organic LED (OLED) displays, and/or any other suitable type of display screen. Artificial reality systems may include a single display screen for both eyes or may provide a display screen for each eye, which may allow for additional flexibility for varifocal adjustments or for correcting a user's refractive error. Some artificial reality systems may also include optical subsystems having one or more lenses (e.g., conventional concave or convex lenses, Fresnel lenses, adjustable fluid lenses, etc.) through which a user may view a display screen.

In addition to or instead of using display screens, some artificial reality systems may include one or more projection systems. For example, display devices in augmented-reality system 2200 and/or virtual-reality system 2300 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial reality content and the real world. Artificial reality systems may also be configured with any other suitable type or form of image projection system.

Artificial reality systems may also include various types of computer vision components and subsystems. For example, augmented-reality system 2100, augmented-reality system 2200, and/or virtual-reality system 2300 may include one or more optical sensors, such as two-dimensional (2D) or three-dimensional (3D) cameras, time-of-flight depth sensors, single-beam or sweeping laser rangefinders, 3D LiDAR sensors, and/or any other suitable type or form of optical sensor. An artificial reality system may process data from one or more of these sensors to identify a location of a user, to map the real world, to provide a user with context about real-world surroundings, and/or to perform a variety of other functions.

Artificial reality systems may also include one or more input and/or output audio transducers. In the examples shown in FIGS. 21 and 23, output audio transducers 2108(A), 2108(B), 2306(A), and 2306(B) may include voice coil speakers, ribbon speakers, electrostatic speakers, piezoelectric speakers, bone conduction transducers, cartilage conduction transducers, and/or any other suitable type or form of audio transducer. Similarly, input audio transducers 2110 may include condenser microphones, dynamic microphones, ribbon microphones, and/or any other type or form of input transducer. In some embodiments, a single transducer may be used for both audio input and audio output.

While not shown in FIGS. 21-23, artificial reality systems may include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial reality devices, within other artificial reality devices, and/or in conjunction with other artificial reality devices.

By providing haptic sensations, audible content, and/or visual content, artificial reality systems may create an entire virtual experience or enhance a user's real-world experience in a variety of contexts and environments. For instance, artificial reality systems may assist or extend a user's perception, memory, or cognition within a particular environment. Some systems may enhance a user's interactions with other people in the real world or may enable more immersive interactions with other people in a virtual world. Artificial reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visuals aids, etc.). The embodiments disclosed herein may enable or enhance a user's artificial reality experience in one or more of these contexts and environments and/or in other contexts and environments.

As noted, the artificial reality systems described herein may be used with a variety of other types of devices to provide a more compelling artificial reality experience. These devices may be haptic interfaces with transducers that provide haptic feedback and/or that collect haptic information about a user's interaction with an environment. The artificial-reality systems disclosed herein may include various types of haptic interfaces that detect or convey various types of haptic information, including tactile feedback (e.g., feedback that a user detects via nerves in the skin, which may also be referred to as cutaneous feedback) and/or kinesthetic feedback (e.g., feedback that a user detects via receptors located in muscles, joints, and/or tendons).

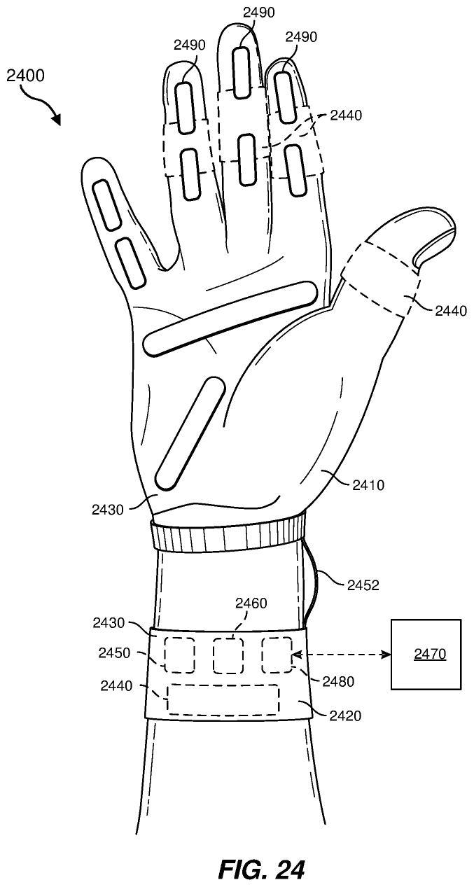

Haptic feedback may be provided by interfaces positioned within a user's environment (e.g., chairs, tables, floors, etc.) and/or interfaces on articles that may be worn or carried by a user (e.g., gloves, wristbands, etc.). As an example, FIG. 24 illustrates a vibrotactile system 2400 in the form of a wearable glove (haptic device 2410) and wristband (haptic device 2420). Haptic device 2410 and haptic device 2420 are shown as examples of wearable devices that include a flexible, wearable textile material 2430 that is shaped and configured for positioning against a user's hand and wrist, respectively. This disclosure also includes vibrotactile systems that may be shaped and configured for positioning against other human body parts, such as a finger, an arm, a head, a torso, a foot, or a leg. By way of example and not limitation, vibrotactile systems according to various embodiments of the present disclosure may also be in the form of a glove, a headband, an armband, a sleeve, a head covering, a sock, a shirt, or pants, among other possibilities. In some examples, the term “textile” may include any flexible, wearable material, including woven fabric, non-woven fabric, leather, cloth, a flexible polymer material, composite materials, etc.

One or more vibrotactile devices 2440 may be positioned at least partially within one or more corresponding pockets formed in textile material 2430 of vibrotactile system 2400. Vibrotactile devices 2440 may be positioned in locations to provide a vibrating sensation (e.g., haptic feedback) to a user of vibrotactile system 2400. For example, vibrotactile devices 2440 may be positioned to be against the user's finger(s), thumb, or wrist, as shown in FIG. 24. Vibrotactile devices 2440 may, in some examples, be sufficiently flexible to conform to or bend with the user's corresponding body part(s).

A power source 2450 (e.g., a battery) for applying a voltage to the vibrotactile devices 2440 for activation thereof may be electrically coupled to vibrotactile devices 2440, such as via conductive wiring 2452. In some examples, each of vibrotactile devices 2440 may be independently electrically coupled to power source 2450 for individual activation. In some embodiments, a processor 2460 may be operatively coupled to power source 2450 and configured (e.g., programmed) to control activation of vibrotactile devices 2440.

Vibrotactile system 2400 may be implemented in a variety of ways. In some examples, vibrotactile system 2400 may be a standalone system with integral subsystems and components for operation independent of other devices and systems. As another example, vibrotactile system 2400 may be configured for interaction with another device or system 2470. For example, vibrotactile system 2400 may, in some examples, include a communications interface 2480 for receiving and/or sending signals to the other device or system 2470. The other device or system 2470 may be a mobile device, a gaming console, an artificial reality (e.g., virtual reality, augmented reality, mixed reality) device, a personal computer, a tablet computer, a network device (e.g., a modem, a router, etc.), a handheld controller, etc. Communications interface 2480 may enable communications between vibrotactile system 2400 and the other device or system 2470 via a wireless (e.g., Wi-Fi, Bluetooth, cellular, radio, etc.) link or a wired link. If present, communications interface 2480 may be in communication with processor 2460, such as to provide a signal to processor 2460 to activate or deactivate one or more of the vibrotactile devices 2440.

Vibrotactile system 2400 may optionally include other subsystems and components, such as touch-sensitive pads 2490, pressure sensors, motion sensors, position sensors, lighting elements, and/or user interface elements (e.g., an on/off button, a vibration control element, etc.). During use, vibrotactile devices 2440 may be configured to be activated for a variety of different reasons, such as in response to the user's interaction with user interface elements, a signal from the motion or position sensors, a signal from the touch-sensitive pads 2490, a signal from the pressure sensors, a signal from the other device or system 2470, etc.

Although power source 2450, processor 2460, and communications interface 2480 are illustrated in FIG. 24 as being positioned in haptic device 2420, the present disclosure is not so limited. For example, one or more of power source 2450, processor 2460, or communications interface 2480 may be positioned within haptic device 2410 or within another wearable textile.

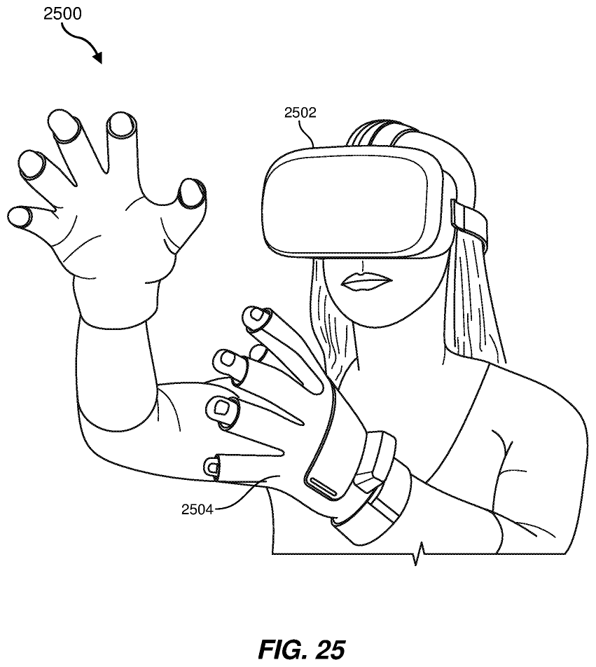

Haptic wearables, such as those shown in and described in connection with FIG. 24, may be implemented in a variety of types of artificial-reality systems and environments. FIG. 25 shows an example artificial reality environment 2500 including one head-mounted virtual-reality display and two haptic devices (i.e., gloves), and in other embodiments any number and/or combination of these components and other components may be included in an artificial reality system. For example, in some embodiments there may be multiple head-mounted displays each having an associated haptic device, with each head-mounted display and each haptic device communicating with the same console, portable computing device, or other computing system.

Head-mounted display 2502 generally represents any type or form of virtual-reality system, such as virtual-reality system 2300 in FIG. 23. Haptic device 2504 generally represents any type or form of wearable device, worn by a use of an artificial reality system, that provides haptic feedback to the user to give the user the perception that he or she is physically engaging with a virtual object. In some embodiments, haptic device 2504 may provide haptic feedback by applying vibration, motion, and/or force to the user. For example, haptic device 2504 may limit or augment a user's movement. To give a specific example, haptic device 2504 may limit a user's hand from moving forward so that the user has the perception that his or her hand has come in physical contact with a virtual wall. In this specific example, one or more actuators within the haptic advice may achieve the physical-movement restriction by pumping fluid into an inflatable bladder of the haptic device. In some examples, a user may also use haptic device 2504 to send action requests to a console. Examples of action requests include, without limitation, requests to start an application and/or end the application and/or requests to perform a particular action within the application.

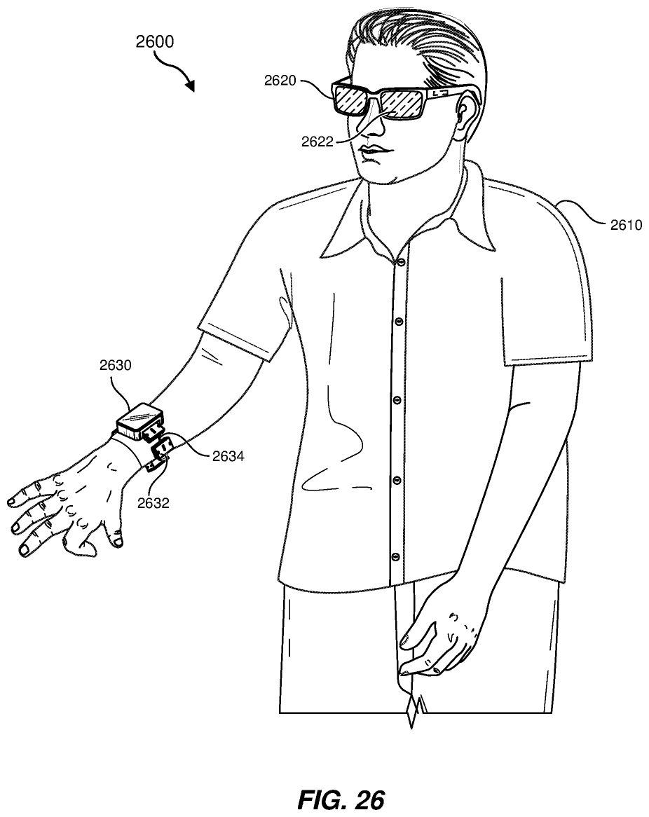

While haptic interfaces may be used with virtual-reality systems, as shown in FIG. 25, haptic interfaces may also be used with augmented-reality systems, as shown in FIG. 26.

FIG. 26 is a perspective view a user 2610 interacting with an augmented-reality system 2600. In this example, user 2610 may wear a pair of augmented-reality glasses 2620 that have one or more displays 2622 and that are paired with a haptic device 2630. Haptic device 2630 may be a wristband that includes a plurality of band elements 2632 and a tensioning mechanism 2634 that connects band elements 2632 to one another.

One or more of band elements 2632 may include any type or form of actuator suitable for providing haptic feedback. For example, one or more of band elements 2632 may be configured to provide one or more of various types of cutaneous feedback, including vibration, force, traction, texture, and/or temperature. To provide such feedback, band elements 2632 may include one or more of various types of actuators. In one example, each of band elements 2632 may include a vibrotactor (e.g., a vibrotactile actuator) configured to vibrate in unison or independently to provide one or more of various types of haptic sensations to a user. Alternatively, only a single band element or a subset of band elements may include vibrotactors.

Haptic devices 2410, 2420, 2504, and 2630 may include any suitable number and/or type of haptic transducer, sensor, and/or feedback mechanism. For example, haptic devices 2410, 2420, 2504, and 2630 may include one or more mechanical transducers, piezoelectric transducers, and/or fluidic transducers. Haptic devices 2410, 2420, 2504, and 2630 may also include various combinations of different types and forms of transducers that work together or independently to enhance a user's artificial-reality experience. In one example, each of band elements 2632 of haptic device 2630 may include a vibrotactor (e.g., a vibrotactile actuator) configured to vibrate in unison or independently to provide one or more of various types of haptic sensations to a user.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive data to be transformed, transform the data, output a result of the transformation to perform a function, use the result of the transformation to perform a function, and store the result of the transformation to perform a function. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference may be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A device comprising an optical configuration, wherein the optical configuration comprises:
a front lens assembly comprising a front adjustable lens;
a waveguide display assembly configured to provide augmented reality light; and
a rear lens assembly comprising a rear adjustable lens, wherein:
the waveguide display assembly is located between the front lens assembly and the rear lens assembly,
a combination of the waveguide display assembly and the rear lens assembly provide a negative optical power for the augmented reality light, and
the device is configured to provide an augmented reality image formed using the augmented reality light within a real-world image.

2. The device of claim 1, wherein the real-world image is formed by real-world light received by the front lens assembly, the real-world light then passing through at least a portion of the waveguide display assembly and the rear lens assembly.

3. The device of claim 1, wherein the device is configured so that, when worn by a user:
the front lens assembly receives real-world light used to form the real-world image, and
the rear lens assembly is located proximate an eye of the user.

4. The device of claim 1, wherein the device is configured so that the negative optical power corrects for vergence-accommodation conflict (VAC) between the real-world image and the augmented reality image.

5. The device of claim 1, wherein the waveguide display assembly provides at least a portion of the negative optical power for the augmented reality light.

6. The device of claim 1, wherein the waveguide display assembly comprises a waveguide display and a negative lens.

7. The device of claim 1, wherein the waveguide display assembly has a negative optical power of between approximately −1.5 D and −2.5 D, where D represents diopters.

8. The device of claim 1, wherein the waveguide display assembly comprises a waveguide display and the waveguide display provides the at least a portion of the negative optical power.

9. The device of claim 1, wherein the waveguide display assembly comprises a grating.

10. The device of claim 1, wherein the front adjustable lens comprises a front adjustable fluid lens having a front substrate, a front membrane, and a front lens fluid located between the front substrate and the front membrane.

11. The device of claim 1, wherein the rear adjustable lens comprises a rear adjustable fluid lens having a rear substrate, a rear membrane, and a rear lens fluid located between the rear substrate and the rear membrane.

12. The device of claim 1, wherein the rear lens assembly provides at least some of the negative optical power.

13. The device of claim 1, wherein the front lens assembly has a positive optical power.

14. The device of claim 13, wherein the positive optical power and the negative optical power are approximately equal in magnitude.

15. The device of claim 1, wherein the rear lens assembly comprises the rear adjustable lens and a supplemental negative lens.

16. The device of claim 1, wherein:
the rear adjustable lens comprises a substrate; and
the substrate has a concave exterior surface.

17. The device of claim 1, wherein:
real-world light is received by the device through the front lens assembly and passes through the waveguide display assembly and the rear lens assembly to form the real-world image;
the augmented reality light is provided by the waveguide display assembly and passes through the rear lens assembly to form the augmented reality image; and
the negative optical power reduces vergence-accommodation conflict between the real-world image and the augmented reality image.

18. The device of claim 1, wherein the device is an augmented reality headset.

19. A method comprising:
receiving real-world light through a front lens assembly and generating a real-world image by directing the real-world light through a waveguide display and a rear lens assembly; and
directing augmented reality light from the waveguide display through the rear lens assembly to form an augmented reality image, wherein:
the waveguide display and the rear lens assembly cooperatively provide a negative optical power for the augmented reality light, and
the front lens assembly, waveguide display, and the rear lens assembly cooperatively provide an approximately zero optical power for the real-world light.

20. The method of claim 19, wherein the waveguide display receives the augmented reality light from an augmented reality light source and directs the augmented reality light out of the waveguide display using a grating.
